(19) United States
(12) Patent Application Publication
(10) Pub. No.: US 2016/0140316 A1
(43) Pub. Date: May 19, 2016

(54) SYSTEMS AND METHODS FOR AUTOMATICALLY EVALUATING MEDICAL PATIENT SYMPTOMS AND PROVIDING TAILORED PRESCRIPTIONS

(71) Applicants: THE REGENTS OF THE UNIVERSITY OF CALIFORNIA, Oakland, CA (US); THE REGENTS OF THE UNIVERSITY OF MICHIGAN, Ann Arbor, MI (US); THE UNITED STATES OF AMERICA REPRESENTED BY THE DEPARTMENT OF VETERANS AFFAIRS, Washington, DC (US)

(72) Inventors: Brennan M.R. Spiegel, Los Angeles, CA (US); William D. Chey, Ann Arbor, MI (US)

(73) Assignees: THE REGENTS OF THE UNIVERSITY OF CALIFORNIA, Oakland, CA (US); THE REGENTS OF THE UNIVERSITY OF MICHIGAN, Ann Arbor, MI (US); THE UNITED STATES OF AMERICA REPRESENTED BY THE DEPARTMENT OF VETERANS AFFAIRS, Washington, DC (US)

(21) Appl. No.: 14/942,493

(22) Filed: Nov. 16, 2015

Related U.S. Application Data
(63) Continuation of application No. PCT/US2014/038512, filed on May 16, 2014.
(60) Provisional application No. 61/824,814, filed on May 17, 2013.

(51) Int. Cl. G06F 19/00

(52) U.S. Cl. CPC G06F 19/3456; G06F 19/363; G06F 19/3425

(57) ABSTRACT

The present disclosure is generally related to automatically evaluating medical patient symptoms and, more specifically, to systems and methods for providing tailored prescriptions, multi-dimensional patient matching and symptom monitoring. In particular, a medical patient completes a questionnaire, responses to the questionnaire are correlated with information obtained from a medical knowledge resource and an integrated symptoms summary is generated based on the responses to the questionnaire and the information obtained from the medical knowledge resource. A tailored prescription is provided to the patient based on the integrated symptoms summary and physician consultation (if applicable), patients are compared to other patients according to questionnaire responses so that they can connect with each other if they chose, and patients are able to monitor symptoms over time so that they can gain insight into whether treatments are working.

### CROSS-REFERENCE TO RELATED APPLICATIONS

This application is a 35 U.S.C. §111(a) continuation of PCT international application number PCT/US2014/038512 filed on May 16, 2014, incorporated herein by reference in its entirety, which claims priority to, and the benefit of, U.S. provisional patent application Ser. No. 61/824,814 filed on May 17, 2013, incorporated herein by reference in its entirety. Priority is claimed to each of the foregoing applications.

The above-referenced PCT international application was published as PCT International Publication No. WO 2014/186780 on Nov. 20, 2014, which publication is incorporated herein by reference in its entirety.

### STATEMENT REGARDING FEDERALLY SPONSORED RESEARCH OR DEVELOPMENT

This work was supported by the U.S. Department of Veterans Affairs, and the Federal Government has certain rights in the invention.

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technical Field

The present disclosure generally relates to a patient-provider portal for automatically evaluating medical patient symptoms and, more specifically, to systems and methods for providing tailored educational prescriptions in response to information obtained from a patient questionnaire.

2. Discussion

Patient-provider interactions typically begin with a patient scheduling an appointment with a provider (e.g., a physician). Often, no information is provided by the patient to the physician prior to the visit, beyond a brief mention as to the purpose for the visit. An unnecessarily long period of time is spent during a visit conveying basic information that could be communicated prior to the visit.

Currently, there are systems available which generate patient billing information and patient health records. However, these systems do not acquire symptom information, for example, from the patient nor provide any indication of a patient's personal need for educational material related to their medical condition. These systems do not generate patient educational prescriptions, let alone tailored educational prescriptions based on patient provided information.

Many medical conditions, such as gastrointestinal (GI) illnesses, are highly prevalent and expensive conditions. Moreover, medical conditions, such as GI illnesses, can diminish health related quality of life (HRQOL), negatively impact work productivity and consume substantial healthcare resources. Yet, despite this burden of illness, there have been few efforts to develop evidence-based tools to assist clinicians in diagnosing, educating and managing patients, such as GI patients, within the context of everyday practice.

It is desirable to develop tools, such as a patient-provider portal, to help overcome barriers to providing high quality care. These barriers include the failure of busy clinicians to recognize and ask the “right” questions to fully understand a patient's clinical complaints, a lack of time to perform a full medical review, such as a GI review, of systems in the ambulatory care setting and uncertainty about the educational needs of individual patients.

### SUMMARY

An aspect of the present disclosure is a method for automatically evaluating medical symptoms and providing a tailored prescription that includes receiving data representative of a medical patient questionnaire information, wherein the medical patient questionnaire information includes information regarding symptoms related to a medical condition. The method may further include receiving data representative of medical knowledge information based on the data representative of the medical patient questionnaire information, wherein the medical knowledge information is, at least partially, based on the medical condition. The method may also include generating an integrated symptoms summary based on the data representative of the medical patient questionnaire information and the data representative of the medical knowledge information. The method may further include receiving data representative of physician consultation information, wherein the physician consultation information is, at least partially, based on the integrated symptoms summary. The method may also include generating a tailored prescription based on the data representative of a medical patient questionnaire, the data representative of the medical knowledge information and the data representative of the physician consultation information.

In another example embodiment, a system for automatically evaluating medical symptoms and providing a tailored prescription includes a first computing device for presenting a medical patient user interface to a patient for entering information regarding symptoms related to a medical condition and a medical knowledge resource database that includes information related to the medical condition. The system may also include an integrated symptoms summary generator module stored on a computer-readable medium that, when executed by a processor, receives data representative of the information regarding symptoms related to the medical condition and data representative of information related to the medical condition and generates an integrated symptoms summary based on data representative of the information regarding symptoms and the data representative of information related to the medical condition. The system may further include a second computing device for presenting a physician user interface for entering physician consultation information and a tailored prescription generator module stored on a computer-readable medium that, when executed by a processor, receives data representative of the symptoms, data representative of the information related to the medical condition and data representative of the physician consultation information and generates a tailored prescription based on data representative of the information regarding the symptoms, data representative of the information related to the medical condition and data representative of the physician consultation information.

In a further example embodiment, a computer-readable storage medium having computer-readable instructions stored thereon and to be executed on a processor of a system for automatically evaluating medical symptoms and providing a tailored prescription includes a tailored prescription generator module that, when executed by a processor, receives data representative of symptoms related to a medical condition of a patient, data representative of information related to the medical condition from a medical knowledge source and data representative of a physician consultation information and generates a tailored prescription based on data representative of the information regarding the symptoms, data representative of the information related to the medical condition and data representative of the physician consultation information, wherein the data representative of the physician consultation information is, at least partially, based on an integral symptoms summary that is generated using data representative of a symptoms of the patient and data representative of a medical knowledge source.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE SEVERAL VIEWS OF THE DRAWING(S)

The present disclosure will be more fully understood by reference to the following drawings which are for illustrative purposes only:

FIG. 1 depicts an example of an automated evaluation of symptoms sequence beginning with a medical patient completing a symptoms questionnaire, including a provider-patient consultation and concluding with a tailored prescription.

FIG. 2 depicts a simple example of a symptoms check sheet.

FIG. 3 through FIG. 6 depict examples of a sequence of user interface pages related to a medical patient questionnaire including a comprehensive symptoms check sheet.

FIG. 7 depicts an example user interface page that allows a medical patient or provider to acquire information related to an integrated symptoms summary.

FIG. 8 through FIG. 10 depict example integrated symptoms summaries.

FIG. 11 through FIG. 13 depict example physician consultation user interface pages that allow input of physician consultation information.

FIG. 14 through FIG. 25 depict example tailored prescription user interface pages based on patient questionnaire information, medical knowledge resource information, physician consultation information and medical educational material.

FIG. 26 depicts an example customization user interface that allows a physician to customize various aspects of a patient questionnaire, a medical knowledge resource and medical educational materials.

FIG. 27 is a flowchart of an exemplary method for assessing an individual's brain activity in accordance with the described embodiments.

FIG. 28 is a flowchart of another exemplary method for assessing an individual's brain activity in accordance with the described embodiments.

FIG. 29 illustrates an exemplary block diagram of a network and computer hardware that may be utilized in an exemplary system in accordance with the described embodiments.

FIG. 30 illustrates an exemplary block diagram of a computer system on which an exemplary system may operate in accordance with the described embodiments.

FIG. 31 is a diagram that illustrates the unique groups of patients with similar symptoms that may be tightly matched by a multi-dimensional mapping feature.

FIG. 32 is a diagram illustrating how the information from a user's HPI may be used by the multi-dimensional matching feature.

FIG. 33 is a diagram illustrating a match between two patients using an embodiment of the multi-dimensional matching feature.

FIG. 34A is a diagram of an initial user interface screen that may be displayed while using the symptom monitoring feature.

FIG. 34B is a diagram of a user interface screen showing symptoms previously reported.

FIG. 35A is a diagram of a user interface screen illustrating symptom changes over time using a line graph function.

FIG. 35B is a diagram of a user interface screen illustrating symptom changes over time using a line graph function, including past symptom entries.

FIG. 36 is a diagram of a user interface screen illustrating symptom changes over time using a line graph function, including breaks where the user has failed to report a symptom at a given time.

FIG. 37A and FIG. 37B show user interface screens after five symptom entries have been made and after fifteen symptom entries have been made, respectively.

FIG. 38A through FIG. 38C show user interface screens illustrating how a user may cause information to be displayed regarding a specific point on the selected symptom line graph by selecting that point on the symptom line graph.

FIG. 39A through FIG. 39C show user interface screens that illustrate possible display changes when a user selects different symptom tabs.

FIG. 40A through FIG. 40C show user interface screens which illustrate how a user can scroll through past symptom entries from the current symptom entry.

FIG. 41 shows a user interface screen that may alert a user that they have so many days before they need to add another timely symptom entry.

### DETAILED DESCRIPTION

The disclosed systems and methods provide patient-provider portals for automatically evaluating medical symptoms, such as symptoms associated with gastrointestinal (GI) illnesses, and for providing tailored educational prescriptions to medical patients. The systems and methods of the present disclosure are designed for use within everyday practice to help clinicians perform assessments and provide tailored feedback and education to their patients. The patient portals, such as healthcare-related online user interfaces, allow patients to interact and communicate with their healthcare providers, such as physicians and hospitals, and integrate electronic health records (EHRs) and personal health records (PHRs) with patient provided information and physician provided information.

The disclosed systems and methods may facilitate requests for prescriptions, requesting and scheduling appointments, viewing test results, sending secure messages to providers, obtaining clinical information before or after a visit, providing alerts when patients are not meeting disease metrics, complying with treatment or keeping up with preventive strategies, etc. The systems and methods of the present disclosure “listen” to the patient, convert patient symptoms to “doctor speak,” report information that is clinically useful, tie patient reports to a targeted educational portfolio and deliver engaging and tailored education to patients (i.e., tailored educational prescriptions).

Before meeting their physician (e.g., GI physician, neurologist, radiologist, allergist), patients may complete an electronic questionnaire, either at home (e.g., on a personal computer) or in a waiting room (e.g., on a tablet device). A standardized, integrated symptoms summary may be generated in response to the information entered via the electronic questionnaire that may be available to a physician in either paper or electronic form, including forms that may integrate with electronic medical records (EMRs), EHRs and PHRs. The integrated symptom summary may allow providers to quickly and accurately understand the patient's clinical profile and assist in focusing attention on the primary complaints. The integrated symptom summary may help providers achieve a deeper, more complete understanding of the patient's clinical complaints in less time than the typical patient-provider encounter.

Furthermore, information obtained via a patient questionnaire may be correlated with information obtained from a medical knowledge resource, such as statistical data related to a group of medical patients having been previously collected, in order to generate an integrated symptom summary. The integrated symptom summary may be used by the provider (e.g., GI physician or clinician) to recommend a tailored “education prescription” that may be available through a unique online site (e.g., patient-provider portal) and aligned with the patient's symptoms questionnaire. The clinician may “prescribe” a targeted, evidenced-based, patient-centered, educational portfolio to their patients, who may receive access to an online educational site. This will ensure that patients have a way to get the information they need to fully understand their symptoms, such as, for example, GI symptoms, and get their questions answered in an evidence-based manner, even if those questions arise outside the walls of the clinic. Thereby, patient activation and patient engagement are encouraged. As a result, better health outcomes may be achieved, health care experiences may be improved and health care costs may be lowered for both the patient and health care provider.

The systems and methods of the present disclosure enhance the office-based patient-provider interaction, focus and streamline the interview process, improve the provider's ability to convey/explain complicated concepts around common symptoms, such as common GI symptoms, provide individualized, high quality educational materials to supplement the face-to-face patient-provider interaction, and engage patients to be a partner in their care plan. Best practice of implementation science may be used to work with usual care practices, minimize burden on clinicians and their staff, address the individualized needs of patients, and provide timely and customizable data that is easy to view, interpret and act upon.

Clinical information collected from the patient questionnaire may inform a tailored prescription generator to create an individualized, evidence-based, understandable educational experience for patients. Thereby, patient care is streamlined, medical access may be improved and chronic disease management may be augmented through patient activation and exchange of information.

The patient questionnaire may be based on best practices for questionnaire development. The disclosed systems and methods may offer a suite of options for physicians to customize the experience (depth and breadth of questions) for their patients and generate provider-friendly reports based on input from physicians that are immediately actionable for clinical care in the office setting. The systems and methods of the present disclosure may offer a range of optional data reports to customize the experience of providers and may contain a unique library of online patient educational materials created using best practices for patient-centered education. The systems and methods of the present disclosure may employ an automated and tested algorithm that selects appropriate educational materials for each individual patient, may allow providers to use animated educational materials during clinic visits to better explain complicated concepts to their patients and may allow providers to automatically email tailored educational materials to their patients for home viewing to supplement and build upon the office based patient-provider encounter. Those of ordinary skill in the art will appreciate that other means of communicating the tailored educational materials to the patient may be utilized. For example, the material could be sent via SMS text or page as well as pushing it to an app running on a mobile device.

The disclosed systems and methods may also create a renewable source of epidemiological and symptom based data for clinical research and market research. The systems and methods of the present disclosure, thereby, have applications for clinical scientists, health systems, and commercial entities (pharmaceutical and medical device manufactures).

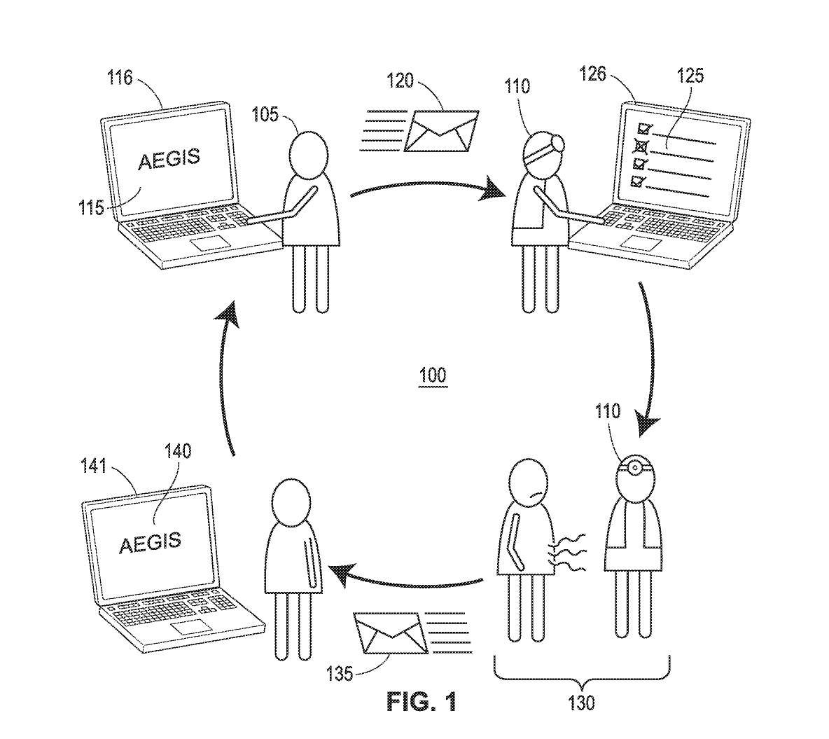

Turning to FIG. 1, an example of an automated evaluation of symptoms sequence is presented 100 beginning with a medical patient (e.g., a GI patient 105) completing a symptoms questionnaire 115 via a patient user interface 116. The symptoms questionnaire 115 may be completed by the patient 105 prior to a visit to the provider's office or may be competed while the patient is in a waiting room at the provider's office. An integrated symptoms summary 120 may be generated by the patient user interface 116 based on information obtained via the patient questionnaire and correlate information retrieved from a medical knowledge source. The integrated symptoms summary 120 may be transmitted to a provider (e.g., physician 110 or clinician) user interface 126 via an electronic communications network. The provider 110 may review the integrated symptoms summary 120 via the provider user interface 126 to produce a tailored prescription 125 which may include a preliminary diagnoses of a medical condition (e.g., GI condition), a patient care plan and a patient education prescription. The patient 105 and the provider 110 may then conduct a patient-provider consultation 130 where the patient 105 and the provider 110 may discuss the integrated symptoms summary 120 and the tailored prescription 125. The patient 105 and the provider 110 may discuss specific topics during the consultation 130 where the patient 105 and/or the provider may ask questions and/or provide answers. The provider 110 may conduct a patient 105 examination during the consultation 130. Subsequent to the consultation 130, the provider 110 may generate a customized tailored prescription 135 based on the tailored prescription 125 and consultation 130 information. Details of each of the components of an automated evaluation of symptoms sequence 100 are discussed elsewhere herein. The patient 105 may then acquire educational material 140 via an educational interface 141 based on the tailored prescription 135.

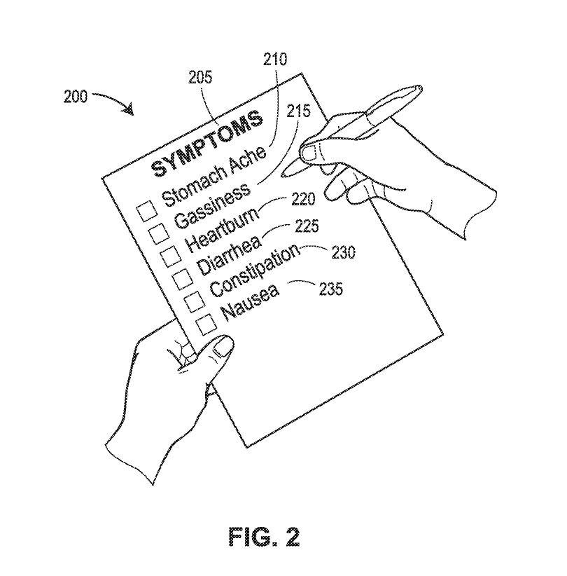

With reference to FIG. 2, an example of a basic symptoms check sheet 200 (e.g., a GI symptoms check sheet) having various symptoms 205 that are generally associated with a specific medical condition (e.g., a GI condition) is depicted. A patient 105 may then simply check a box next to the symptom 210 through 235 that is, or symptoms 210 through 235 that are, applicable to his circumstance. For example, in the context of a GI condition, the symptoms 205 may include stomach ache 210, gassiness 215, heartburn 220, diarrhea 225, constipation 230 and nausea 235. It should be understood that any number of symptoms 205 may be included within a symptoms check sheet 200 and that a symptoms check sheet 200 may form, at least a part, of a patient questionnaire 115. Further details of symptoms check sheets 200 and patient questionnaires 115 are discussed elsewhere herein.

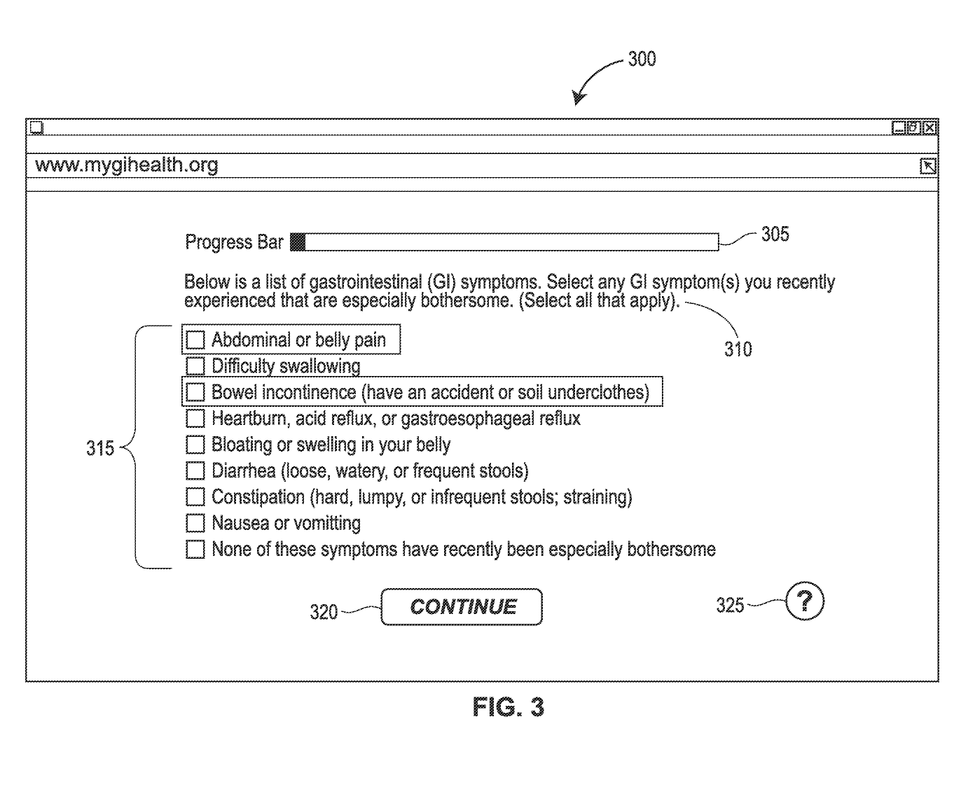

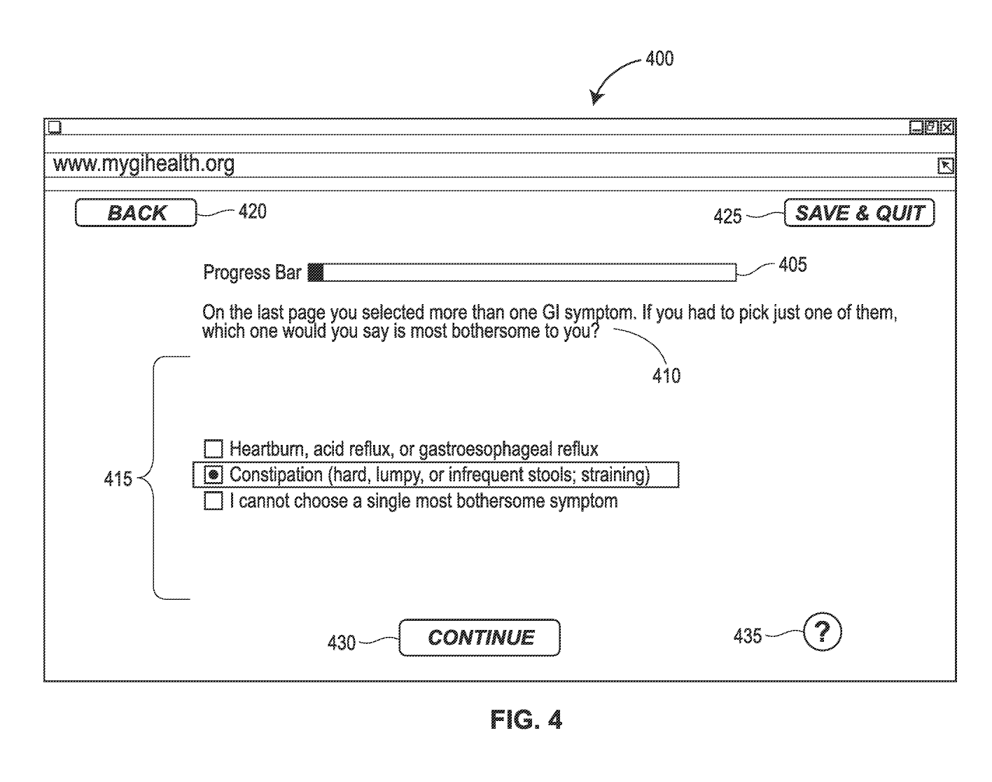

Turning to FIG. 3 through FIG. 6, examples of a sequence of patient interface pages 300, 400, 500, 600, related to a medical patient questionnaire 115 are depicted. FIG. 3 depicts an initial patient interface page 300 which may include a questionnaire completion bar 305, general initial instructions 310, a list of symptoms 315 (e.g., symptoms related to a GI condition), a continue button 320 and a questions/help button 325. The questionnaire completion bar 305 may indicate to the patient 105 approximately how much of the questionnaire 115 has been completed and how much of the questionnaire 115 remains to be completed. When a patient 105 selects any one, or all, of the symptoms 315 and selects the continue button 320 via a user input device (e.g., a mouse), a second patient interface page 400 of FIG. 4 may be displayed. When a patient 105 selects the questions/help button 325, additional information related to how to complete the questionnaire 115 or specific information related to any one of the symptoms 315 may be displayed.

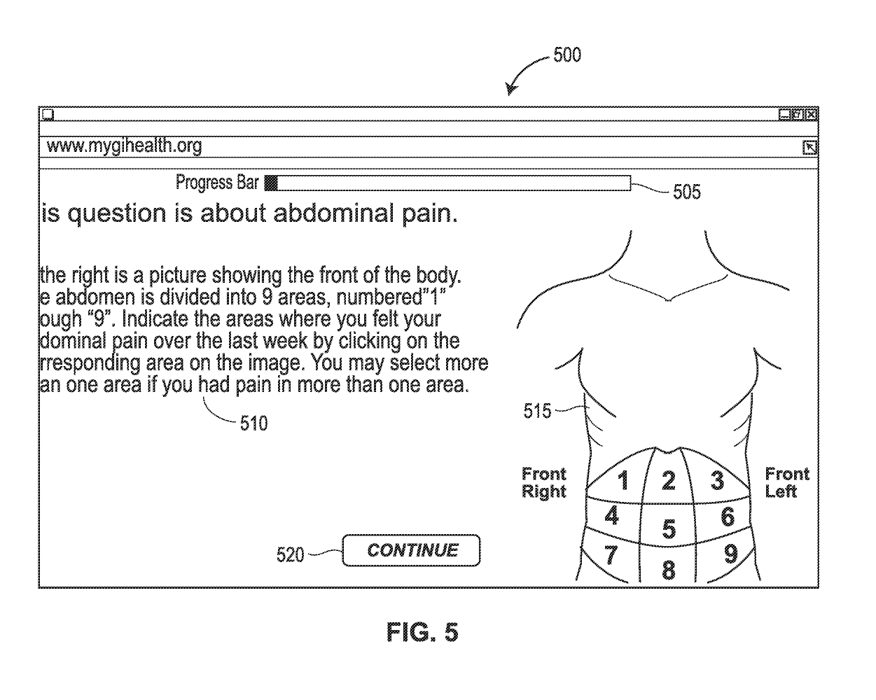

The second patient interface page 400 may include a questionnaire completion bar 405, general instructions related to the second patient interface 410, a list of selectable responses 415, a back button 420, a save and quit button 425, a continue button 430 and a questions/help button 435. When the back button 420 is selected by the patient 105, the initial patient interface page 300 may be displayed. When the save and quit button 425 is selected by the patient 105, the questionnaire 115 may be saved prior to exiting such that the patient 105 may return at a later time to complete only the remaining portions of the questionnaire 115 without having to start from the initial patient interface page 300. When the patient 105 selects the continue button 430, a third patient interface page 500 of FIG. 5 may be displayed.

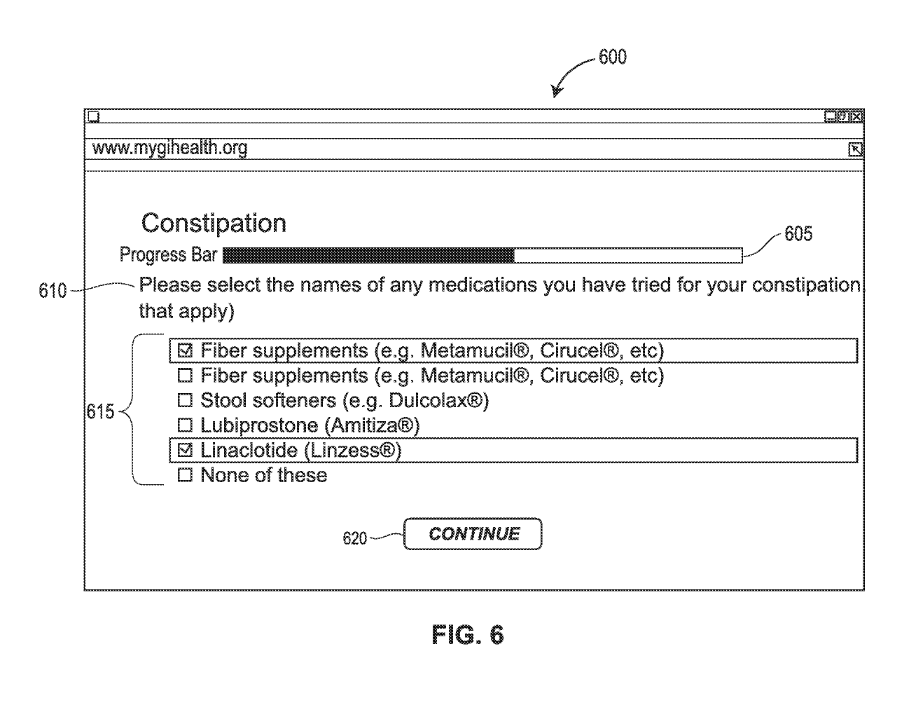

The third patient interface page 500 may include a questionnaire completion bar 505, additional information 510 related to a symptom 315 (e.g., abdominal pain) that may have been selected in the initial patient interface page 300, an animation 515 related to the symptom 315 and a continue button 520. The additional information 510 and the animation 515 may provide additional educational information to the patient 105 and/or may allow the patient 105 to provide additional information, such as where the abdominal pain is located. When the patient 105 selects the continue button 520, a fourth patient interface page 600 of FIG. 6 may be displayed.

The fourth patient interface page 600 may include a questionnaire completion bar 605, an instruction related to medication(s) that the patient 105 may have tried 610, a selectable list of medications 615 which may be selected and a continue button 620. In the context of a GI condition, the selectable list of medications 615 may include fiber supplements, laxatives, stool softeners, lubiprostone, linaclotide, along with a “none of these” option. Specific brand names of the individual medications may be provided along with any given medication. When the patient 105 selects the continue button 620, the questionnaire 115 may continue to another patient interface page (not shown) similar to the second user interface page 400 only related to a different symptom 315 and a sequence similar to user interface pages 500 through 600 may be completed. Once each of the symptoms 315 have been presented via a series of pages 400 through 600 and completed by the patient 105, the questionnaire may be saved to a computer-readable medium, for example.

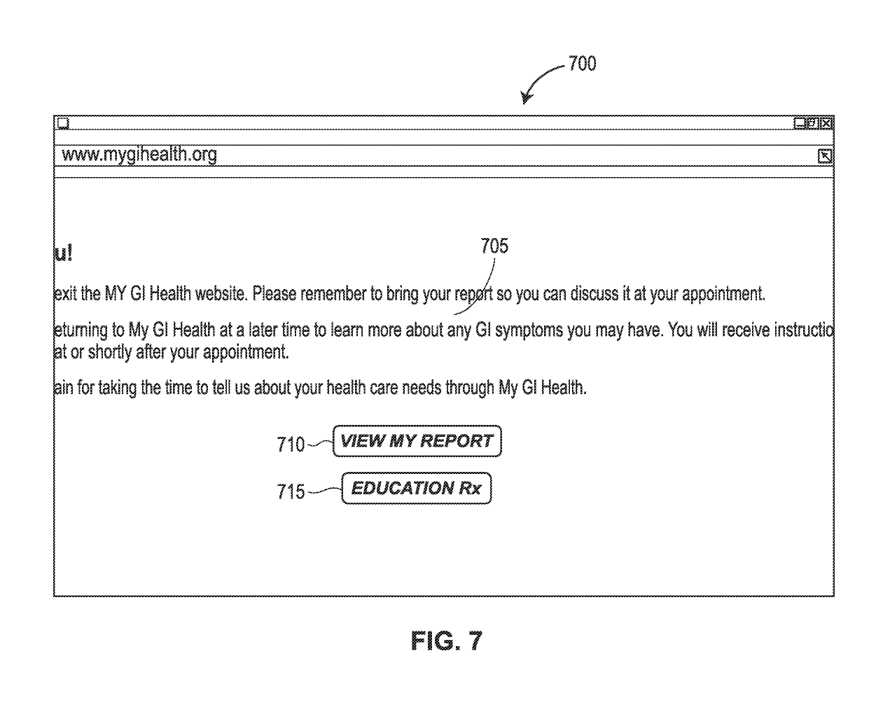

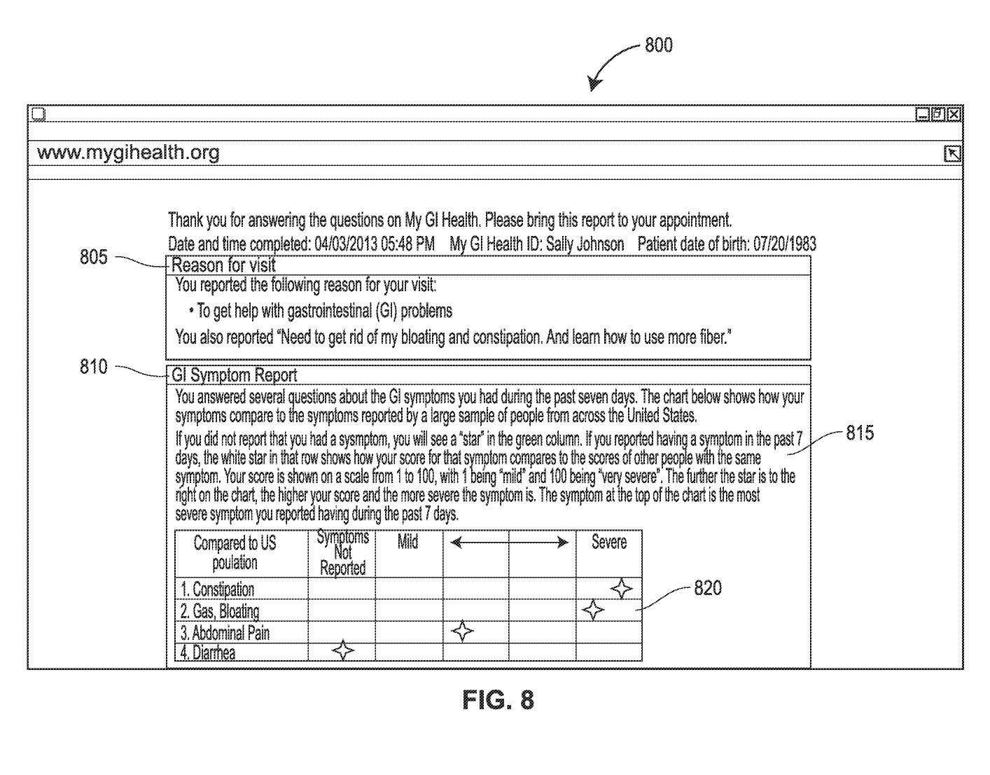

With reference to FIG. 7, an example final user interface page 700, that allows a medical patient 105, to acquire information related to an integrated symptoms summary 120 may be displayed. The final user interface page 700 may include instructions related to the integrated symptoms summary page 705, a view my report button 710 and an education Rx button 715. When a patient 105 selects the view my report button 710, an integrated symptoms summary 120 (e.g., integrated symptoms summary 800, 900, 1000 of FIG. 8 through FIG. 10) may be displayed. When a patient 105 selects the education Rx button 715, additional educational material may be presented to the patient 105 related to the symptoms 315, for example.

Turning now to FIG. 8 through FIG. 10, example integrated symptoms summaries 800, 900, 1000 are depicted. An integrated symptoms summary 120 may be generated based on information obtained from a patient questionnaire 115 and further based on correlated information obtained from a medical knowledge resource. The medical knowledge resource may be a database containing data representative of symptoms of other medical patients having a similar medical condition. The medical knowledge resource may further include data representative of a correlation between medical symptoms and diagnosis. Furthermore, the medical knowledge resource may include data representative of a correlation between medical symptoms, diagnosis and care plans.

An overview of an integrated symptoms summary page 800, as depicted in FIG. 8, may include a purpose for visit section 805 and a symptoms report section 810. The symptoms report section 810 may include a written portion 815 which describes various aspects of the symptoms 315 which were selected by the patient 105 in the symptoms questionnaire 115 of FIG. 1 through FIG. 6. The symptoms report section 810 may further include a tabular form 820 which depict a ranking of the symptoms 315 selected by the patient 105. As described in detail elsewhere herein, an integrated symptoms summary (e.g., integrated symptoms summary 800, 900, 1000 of FIG. 8 through FIG. 10) may be automatically generated based on patient 105 entered information of a patient questionnaire 115 and/or based on information acquired from a medical knowledge resource.

The integrated symptoms summary 900a depicts an enlarged view of portions of the integrated symptoms summary 800 of FIG. 8. The integrated symptoms summary 900a may include a symptom report status bar 905a, a symptom report 910a, an interpretation section 915a, a symptom score section 925a with a list of individual symptom responses 920a. The symptom report 910a, the interpretation section 915a, the symptom score section 925a and the list of individual symptom responses 920a may be generated in response to patient 105 information entered into a questionnaire 115 and/or information acquired from a medical knowledge resource.

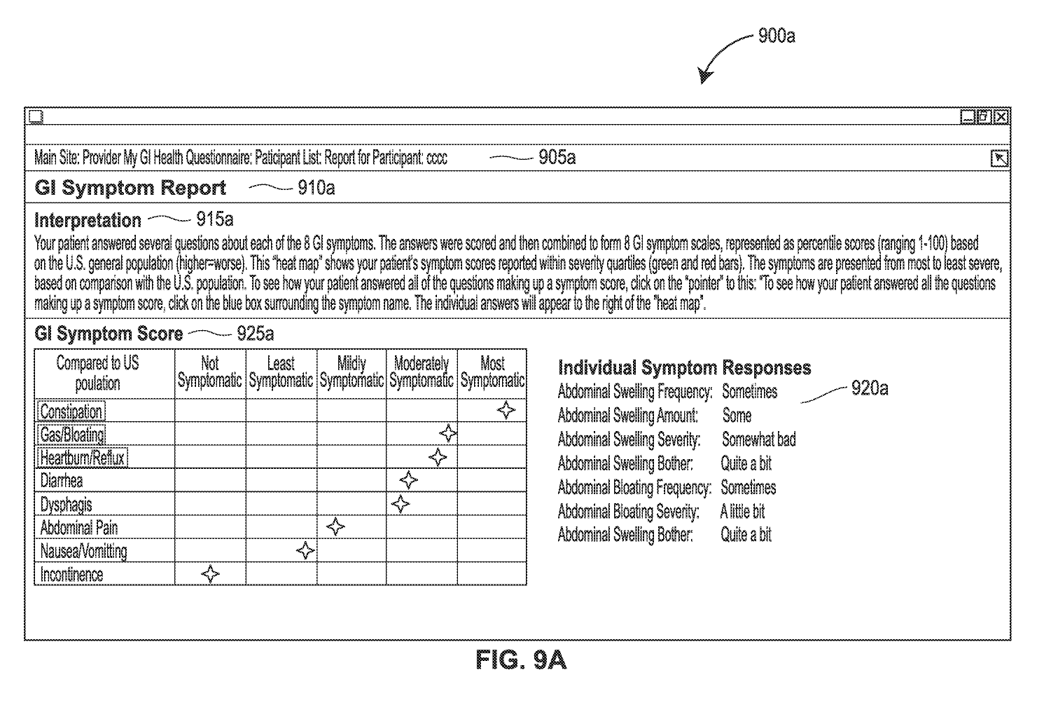

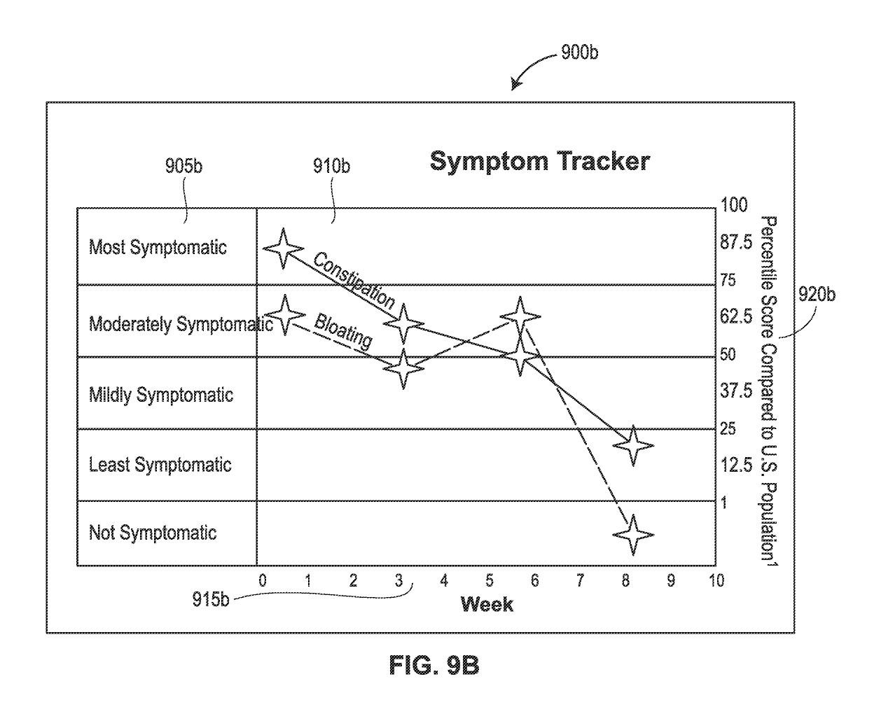

In FIG. 9B, the symptom tracker 900b depicts a composite score for each symptom score 925a (see FIG. 9A) generated by the patient 105 and may use a 0-100 scale, which corresponds to a percentile ranking as compared to the U.S. population. The symptoms may be scored by severity 905b and may be further categorized into one of five levels, including, for example, “no symptoms” as the lowest severity level, and then for those with symptoms, “least symptomatic” as the 0-25^{th} percentile, “mildly symptomatic” as the 26-50^{th} percentile, “moderately symptomatic” as the 51-75^{th} percentile and “most symptomatic” as the 76-100^{th} percentile. These four quartiles (0-25, 26-50, 51-75 and 76-100) may then be illustrated using a heat map that visually demonstrates the symptom profile of the user. Each of the four quartiles may be represented as different bands 910b on the heat map, with the “no symptoms” category also represented as a band at the lowest end of the heat map. The symptom scores 925a may be presented within severity quartiles over time (weeks) 915b and are expressed here as a percentile rank compared to people in the U.S. population 920b reporting the same symptom.

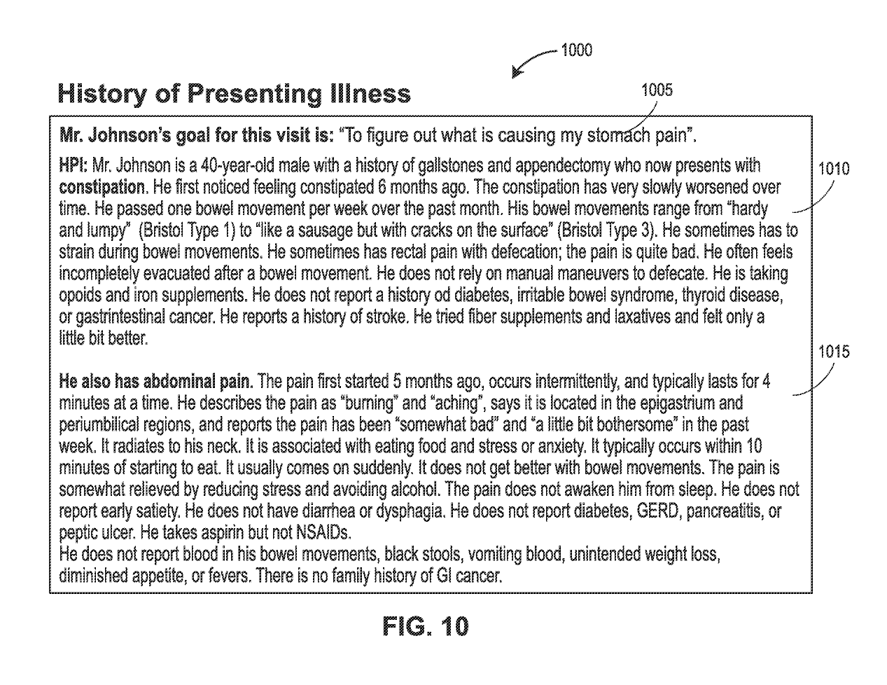

The integrated symptoms summary 1000 of FIG. 10 may include a general patient goal 1005, a history presenting illness (HPI) section 1010 and a detail patient symptom section 1015. The general patient goal 1005, the history presenting illness (HPI) section 1010 and the detail patient symptom section 1015 may allow the provider 110 to formulate a plan for a patient-provider consultation 130 and/or to begin preparation of a tailored prescription 135. A tailored prescription 135 may be generated based on information obtained from a patient questionnaire 115, further based on correlated information obtained from a medical knowledge resource, information obtained from a consulting physician or clinician and information obtained from medical educational material. The medical knowledge resource may be a database containing data representative of symptoms of other medical patients having a similar medical condition. The medical knowledge resource may further include data representative of a correlation between medical symptoms and diagnosis. Furthermore, the medical knowledge resource may include data representative of a correlation between medical symptoms, diagnosis and care plans. The medical educational material may be a database containing data representative of symptoms of other medical patients having a similar medical condition. The medical educational material may further include data representative of a correlation between medical symptoms and diagnosis. Furthermore, the medical educational material may include data representative of a correlation between medical symptoms, diagnosis and care plan and may also include diet and lifestyle recommendations as well as medical therapies. The medical educational material may also include alpha-numeric text based information, image based information, audio information and video information related to various medical symptoms, medical conditions, human anatomy, human organ function, prescription medications, over the counter medical therapies, etc.

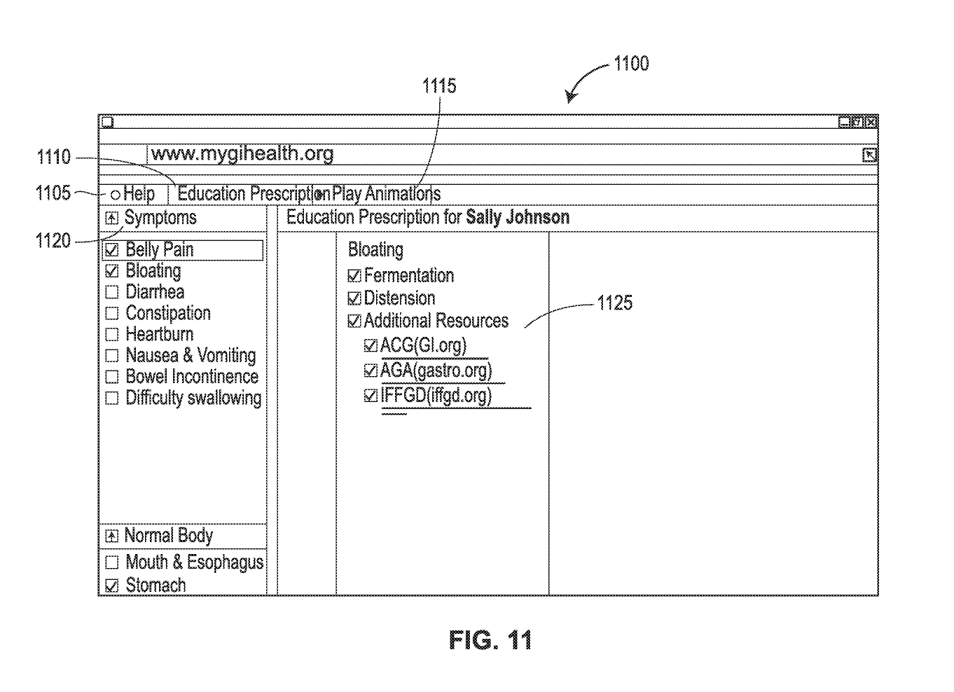

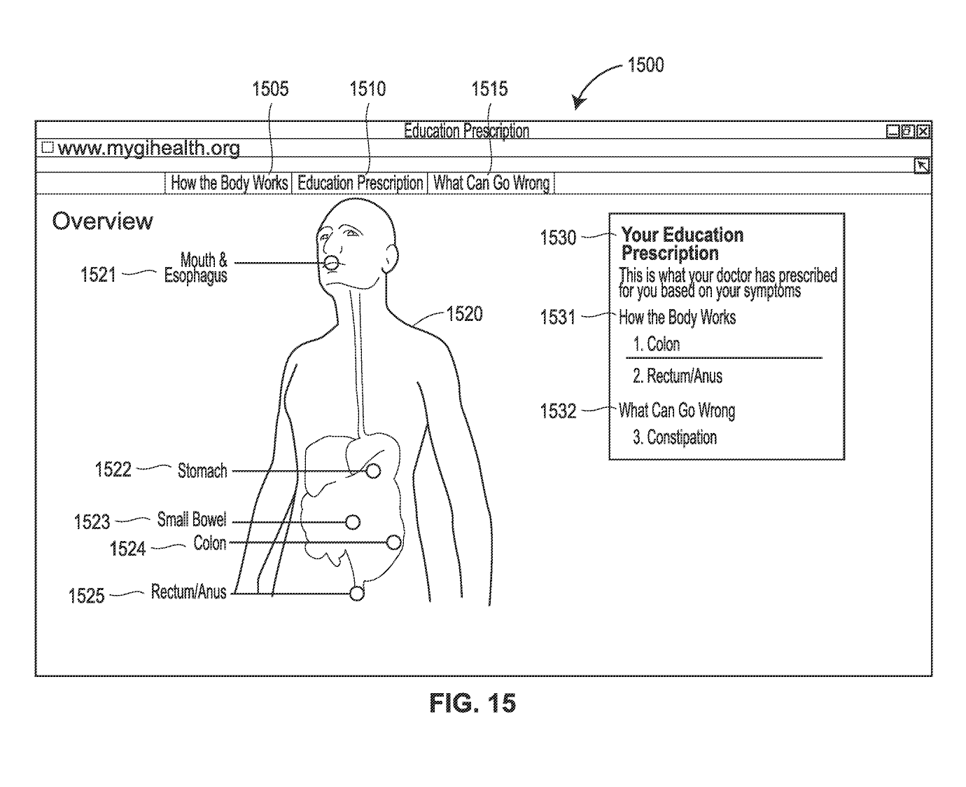

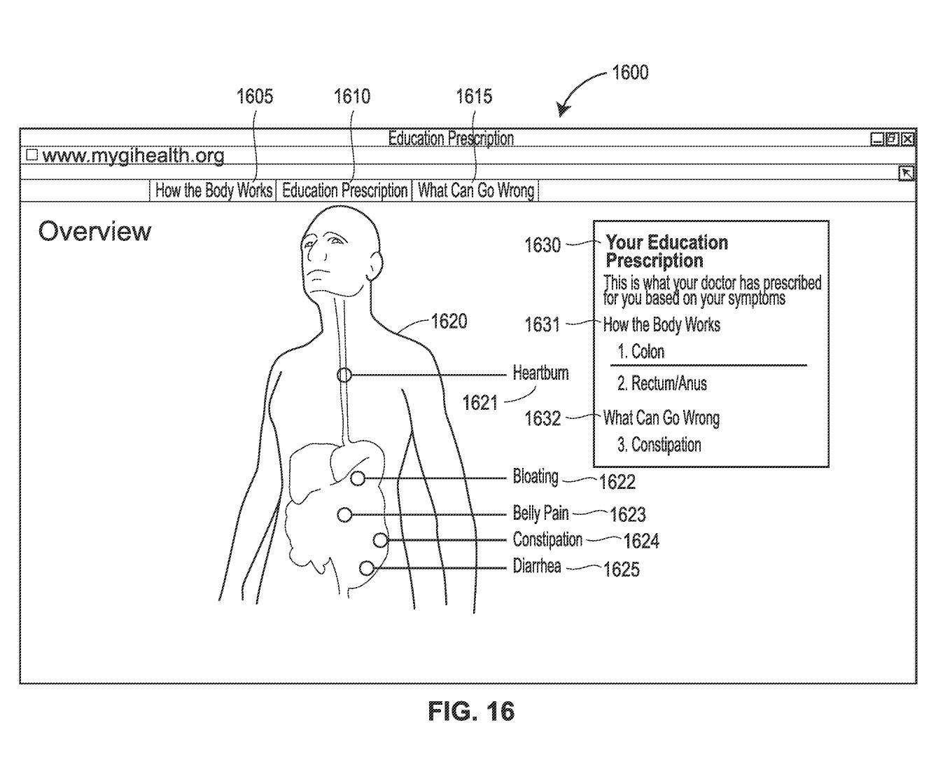

Turning to FIG. 11 through FIG. 13, example physician consultation pages 1100, 1200, 1300 are depicted that allow input of physician consultation 130 information. The first physician consultation page 1100 of FIG. 11 may include help tab 1105, an education prescription tab 1110 and a play animation tab 1115. When a provider (e.g., a GI physician) selects the help tab 1105, information related to any portion of the sequence 100 or the physician consultation pages 1100, 1200, 1300 may be displayed. When a provider selects the education tab 1110, a list of symptoms 1120 along with an education prescription 1125 may be displayed corresponding to the patient 105. The list of symptoms 1120 may correspond to the symptoms 315. The education prescription 1125 may correspond to a specific one of the symptoms 1120 that is selected (e.g., bloating). When a provider 110 selects the play animation tab 1115, a list of selectable animations (e.g., animations similar to animations 1500, 1600, 1700, 1800, 1900 of FIG. 15 through FIG. 19) may be displayed related to belly pain.

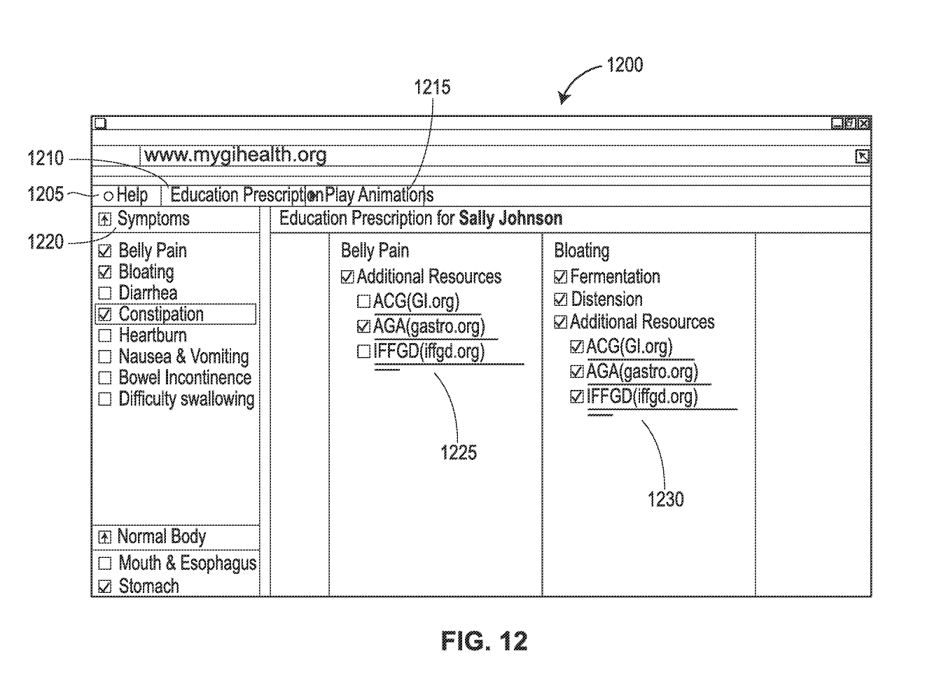

When a provider 110 selects two symptoms 1120 (e.g., belly pain and bloating), the physician consultation page 1200 of FIG. 12 may be displayed. The physician consultation page 1200 may include a help tab 1205, an education prescription tab 1210 and a play animation tab 1215. When a provider 110 selects the education prescription tab 1210, because both the belly pain and bloating symptoms 1120 were selected in the physician consultation page 1100, a list of education prescription information related to belly pain 1225 and a list of education prescription information related to bloating 1230 may be included in the physician consultation page 1200. When a provider 110 selects the play animation tab 1215, a list of selectable animations (e.g., animations similar to animations 1500, 1600, 1700, 1800, 1900 of FIG. 15 through FIG. 19) may be displayed related to belly pain and bloating.

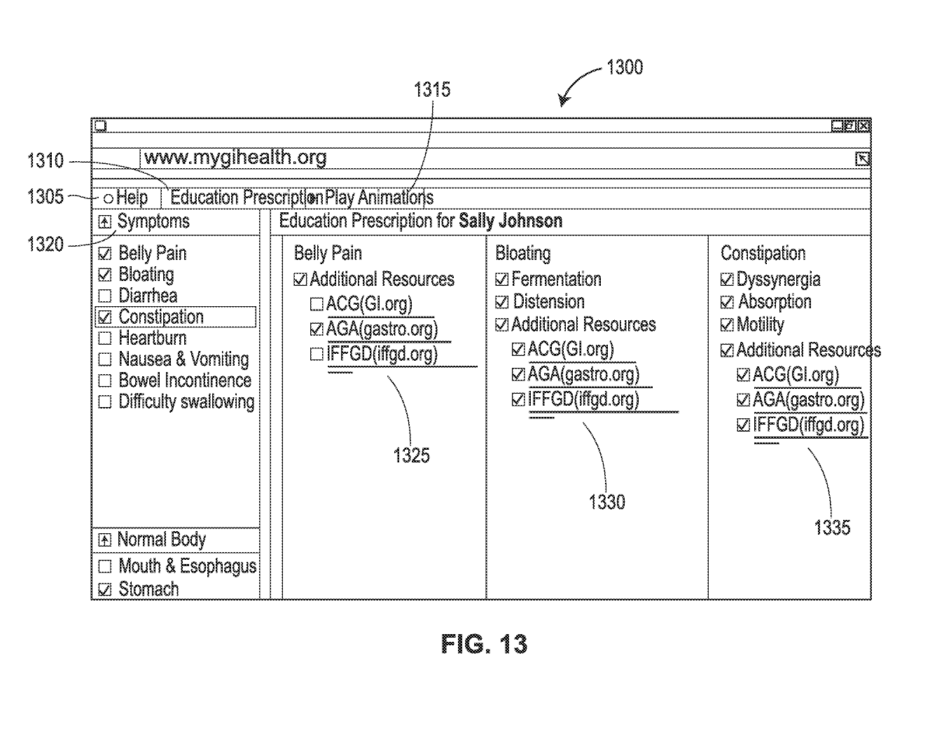

When a provider 110 selects three symptoms 1220, 1320 (e.g., belly pain, bloating and constipation), the physician consultation page 1300 of FIG. 13 may include a help tab 1305, an education prescription tab 1310 and a play animation tab 1315. When a provider 110 selects the education prescription tab 1310, because the belly pain, bloating and constipation symptoms 1220 were selected in the physician consultation page 1200, a list of education prescription information related to belly pain 1325, a list of education prescription information related to bloating 1330 and a list of education prescription information related to constipation 1335 may be included in the physician consultation page 1300. When a provider 110 selects the play animation tab 1315, a list of selectable animations (e.g., animations similar to animations 1500, 1600, 1700, 1800, 1900 of FIG. 15 through FIG. 19) may be displayed related to belly pain, bloating and constipation, for example. When a provider 110 selects the help tab 1305, information related to belly pain, bloating and constipation may be displayed.

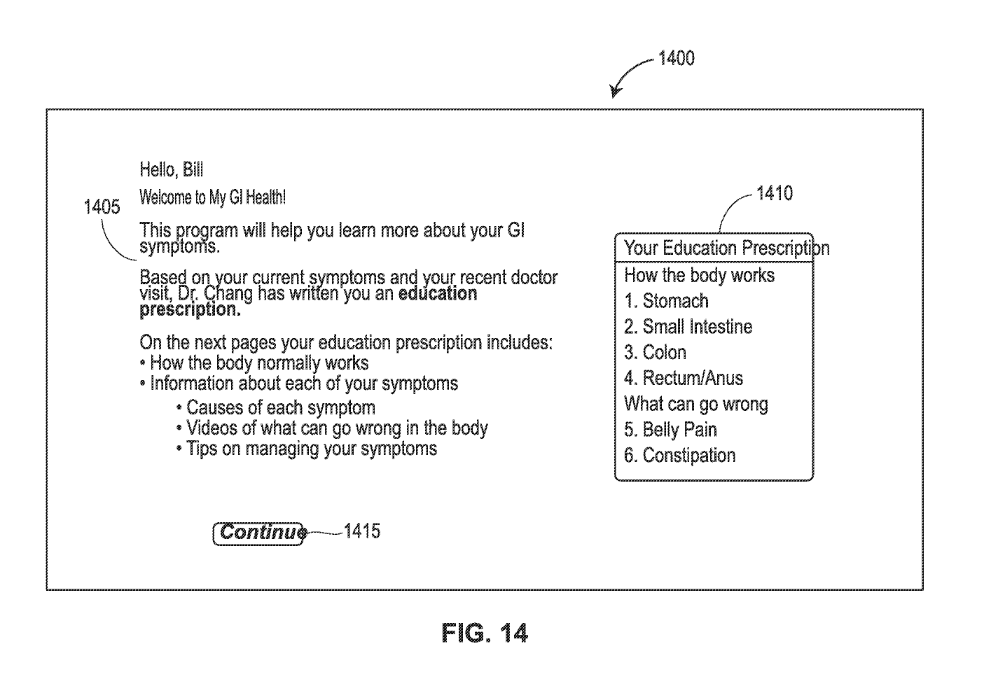

Once the provider selects various education prescription information 1125, 1230, 1335, a tailored prescription 135 may be generated based on the patient questionnaire 115, the integrated symptoms summary 120 and the patient-provider consultation 130. The tailored prescription 135 may include various tailored prescription portions as depicted in FIG. 14 through FIG. 25.

Turning to FIG. 14 through FIG. 25, example tailored prescription user interface pages 1400 through 2500, based on the patient questionnaire information 120; medical knowledge resource information 915, physician consultation information 130 and medical educational material 1125, 1230, 1335 may be generated. The first tailored prescription user interface page 1400 may include a general patient welcome 1405, a patient education prescription list 1410 and a continue button 1415. When a patient 105 selects any one of the items on the patient education prescription list 1410, more detail information will be presented. When a patient 105 selects the continue button 1415, the second tailored prescription user interface page 1500 of FIG. 15 may be displayed.

The first tailored prescription user interface page 1500 of FIG. 15 may include a how the body works tab 1505, an education prescription tab 1510 and a what can go wrong tab 1515. When a patient 105 selects the how the body works tab 1505, an animated illustration of a human 1520 may be displayed, for example, including the mouth and esophagus 1521, the stomach 1522, the small bowel 1523, the colon 1524 and the rectum/anus 1525. While the first tailored prescription user interface page 1500 depicts various portions of the human 1520 related to GI related conditions, any given tailored prescription user interface page may include organs related to any other specific medical condition. The first tailored prescription user interface page 1500 may further include an education prescription list 1530 including a how the body works list 1531 and a what can go wrong list 1532. When a patient 105 selects the what can go wrong tab 1515, for example, the second tailored prescription user interface page 1600 may be displayed.

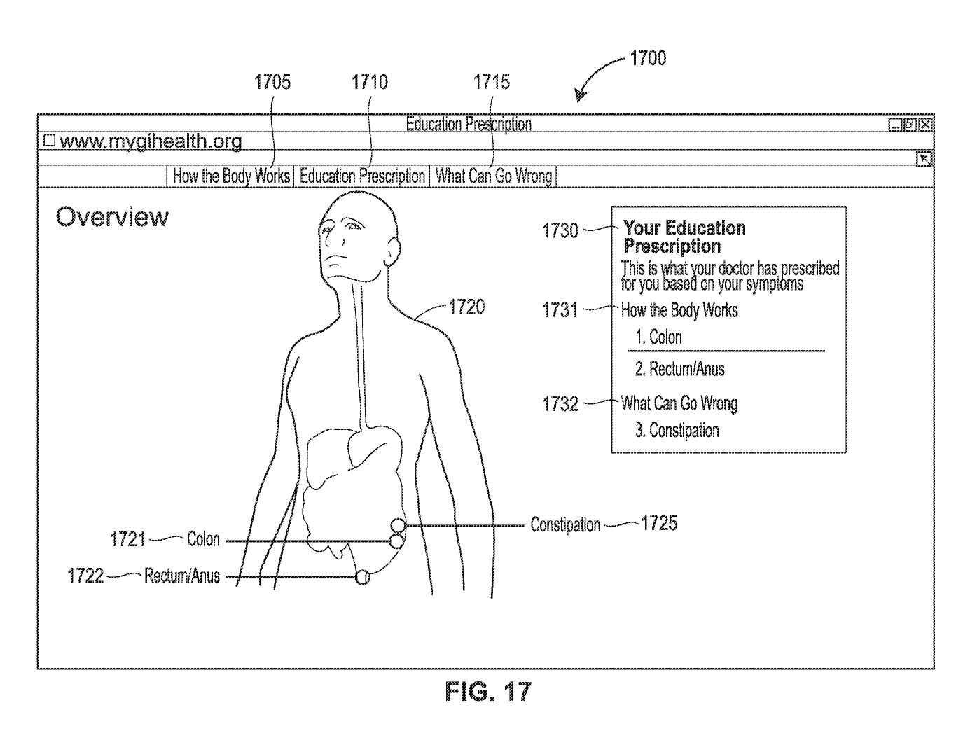

The second tailored prescription user interface page 1600 may include a how the body works tab 1605, an education prescription tab 1610 and a what can go wrong tab 1615. The second tailored prescription user interface page 1600 may also include an illustration of a human body 1620 including a list of things that can go wrong, for example, heartburn 1621, bloating 1622, belly pain 1623, constipation 1624 and diarrhea 1625. Other symptoms including, but not limited to, nausea/vomiting, bowel incontinence and difficulty swallowing (not shown) may also be presented to the user as things that can go wrong. While the second tailored prescription user interface page 1600 may include things that can go wrong associated with a GI condition, it should be understood that any given what can go wrong tab of a tailored prescription user interface page may display items related to any given medical condition. The second tailored prescription user interface page 1600 may further include an education prescription section 1630 including a how the body works list 1631 and a what can go wrong list 1632. When a patient 105 selects the constipation item, for example, from the what can go wrong list 1632, a third tailored prescription user interface page 1700 of FIG. 17 may be displayed.

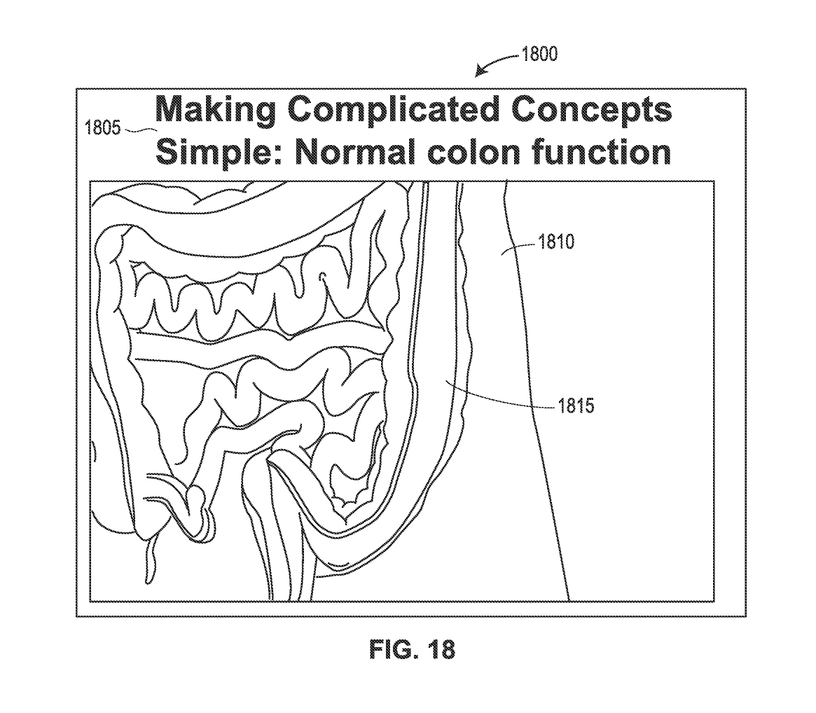

The third tailored prescription user interface page 1700 may include a how the body works tab 1705, an education prescription tab 1710 and a what can go wrong tab 1715. The third tailored prescription user interface page 1700 may also include an illustration of a human body 1720 including a colon 1721, a rectum/anus 1722 and a constipation item 1725. The third tailored prescription user interface page 1700 may further include an education prescription listing section 1730 including a how the body works listing 1731 and a what can go wrong listing 1732. When the patient 105 selects the constipation item 1725, the fourth tailored prescription user interface page 1800 of FIG. 18 may be displayed.

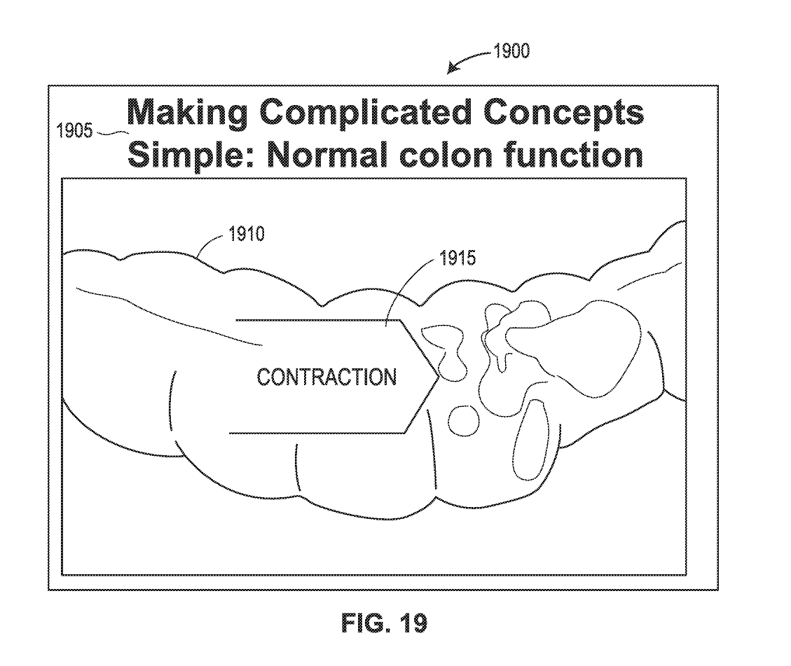

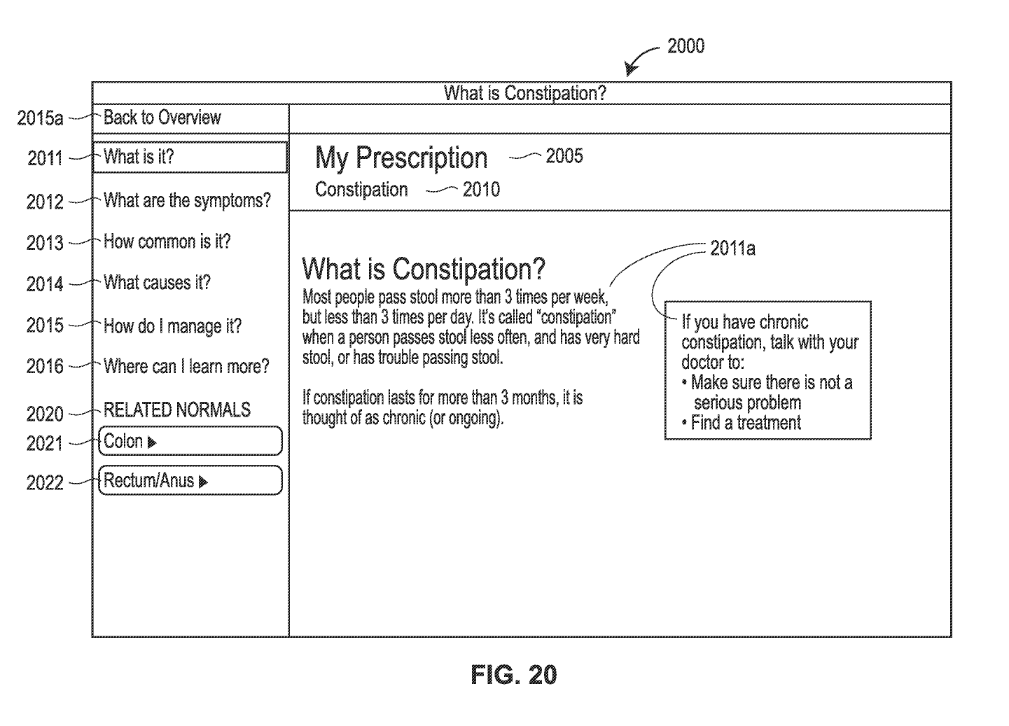

The fourth tailored prescription user interface page 1800 may illustrate making complicated concepts simple: normal colon function 1805 including an exploded, section view, of a human body 1810 showing internal organs with “normal” functioning colon visually differentiated 1815. After a short time delay (which may be customizable), the fifth tailored prescription user interface page 1900 of FIG. 19 may be displayed. The fifth tailored prescription user interface page 1900 may illustrate making complicated concepts simple 1200 including an exploded view of a section of a colon 1910 with a contraction 1915. A patient 105 may obtain a better understanding of the function of a colon and a brief prelude to constipation by viewing the fourth and fifth tailored prescription user interface pages 1800, 1900. After a short time delay (which may be customizable), a sixth tailored prescription user interface page 2000 of FIG. 20 may be displayed.

The sixth tailored prescription user interface page 2000 may include a my prescription title 2005, a symptom title 2010 (e.g., constipation), a what is it selectable item 2011, a what are the symptoms selectable item 2012, a how common is it selectable item 2013, a what causes it selectable item 2014, how do I manage it 2015 and a where can I learn more selectable item 2016. The sixth tailored prescription user interface page 2000 may also include a back to overview button 2015a, a related normals section 2020, a colon tab 2021 and a rectum/anus tab 2022. When a patient selects the what is it selectable item 2011, the what is constipation information 2011a may be displayed.

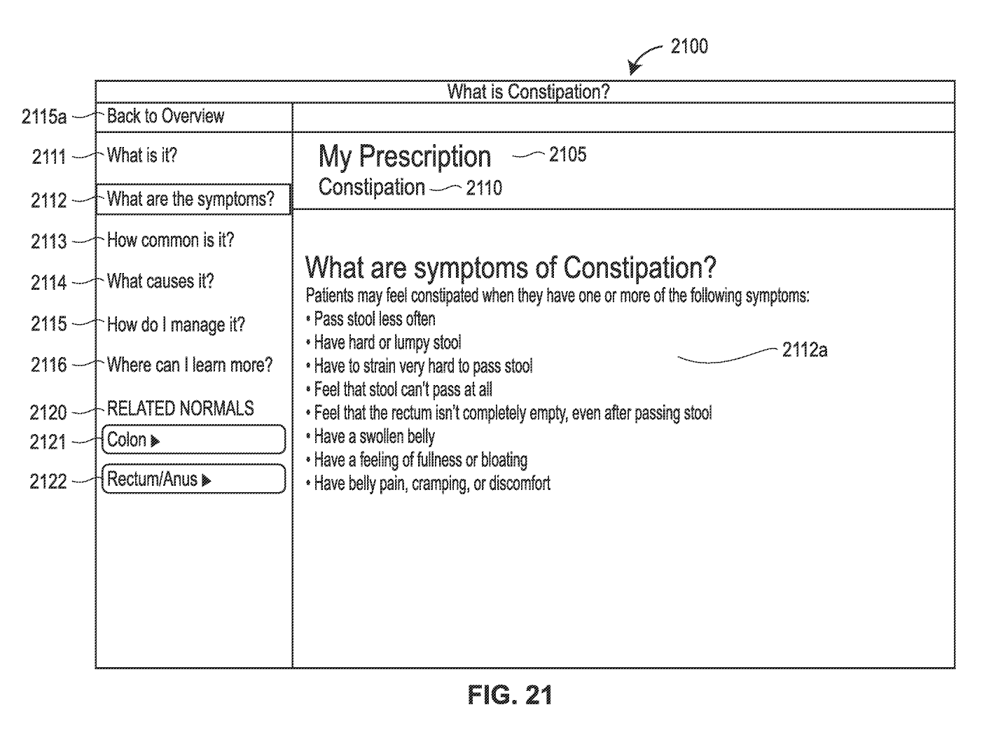

When a patient selects the what are the symptoms selectable item 2012, 2112, the seventh tailored prescription user interface page 2100 of FIG. 21 may be displayed. The seventh tailored prescription user interface page 2100 may include a my prescription title 2105, a symptom title 2110 (e.g., constipation), a what is it selectable item 2111, a what are the symptoms selectable item 2112, a how common is it selectable item 2113, a what causes it selectable item 2114, how do I manage it 2115 and a where can I learn more selectable item 2116. The seventh tailored prescription user interface page 2100 may also include a back to overview button 2115a, a related normals section 2120, a colon tab 2121 and a rectum/anus tab 2122. When the patient selects the what are symptoms selectable item 2012, 2112, the what are symptoms of constipation information 2112a may also be displayed.

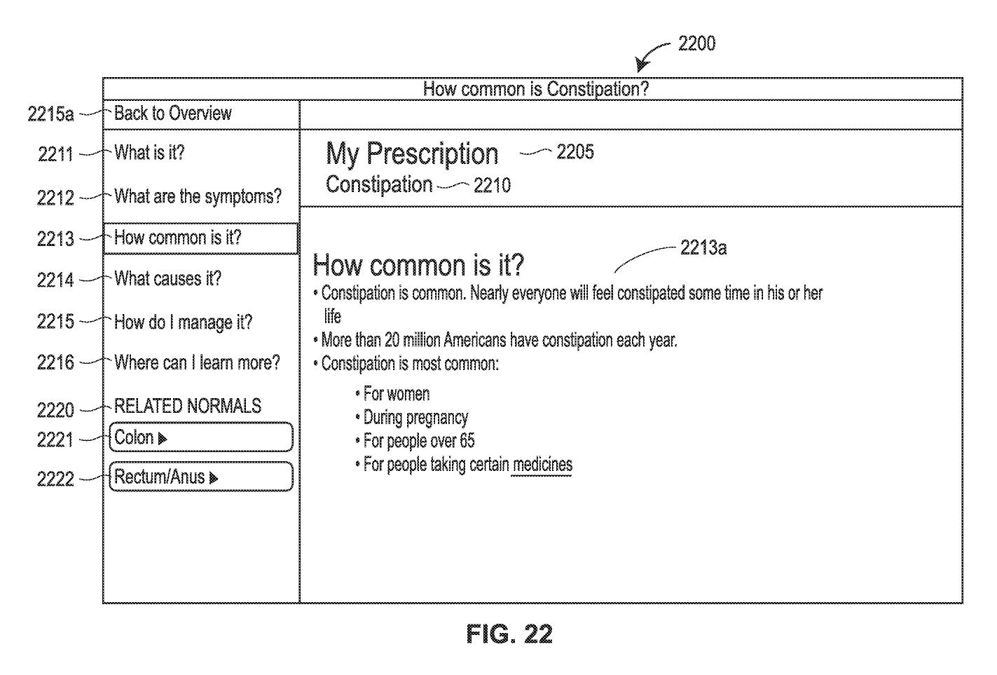

When a patient selects the how common is it selectable item 2113, 2213, the eighth tailored prescription user interface page 2200 of FIG. 22 may be displayed. The eighth tailored prescription user interface page 2200 may include a my prescription title 2205, a symptom title 2210 (e.g., constipation), a what is it selectable item 2211, a what are the symptoms selectable item 2212, a how common is it selectable item 2213, a what causes it selectable item 2214, how do I manage it 2215 and a where can I learn more selectable item 2216. The eighth tailored prescription user interface page 2200 may also include a back to overview button 2215a, a related normals section 2220, a colon tab 2221 and a rectum/anus tab 2222. When the patient selects the how common is it selectable item 2113, 2213, the how common is it information 2213a may also be displayed.

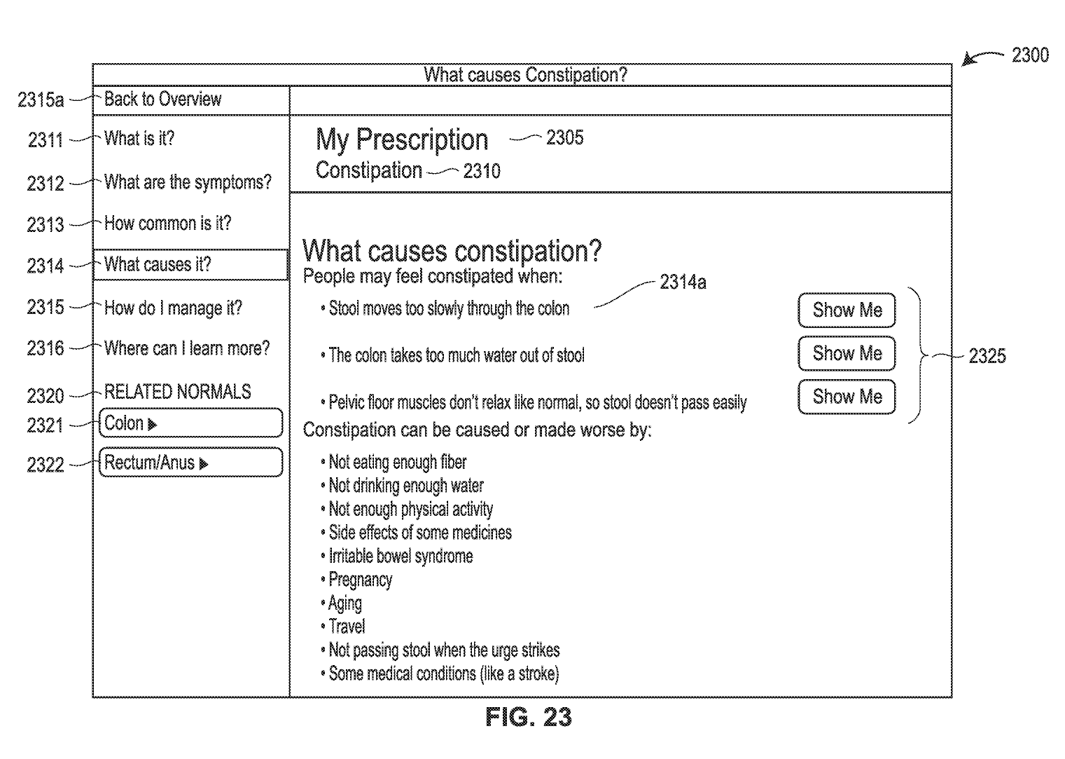

When a patient selects the what causes it selectable item 2214, 2314, the ninth tailored prescription user interface page 2300 of FIG. 23 may be displayed. The ninth tailored prescription user interface page 2300 may include a my prescription title 2305, a symptom title 2310 (e.g., constipation), a what is it selectable item 2311, a what are the symptoms selectable item 2312, a how common is it selectable item 2313, a what causes it selectable item 2314, how do I manage it 2315 and a where can I learn more selectable item 2316. The ninth tailored prescription user interface page 2300 may also include a back to overview button 2315a, a related normals section 2320, a colon tab 2321 and a rectum/anus tab 2322. When the patient selects the what causes it selectable item 2214, 2314, the what causes constipation information 2314a may also be displayed. The ninth tailored prescription user interface page 2300 may also include the show me tabs 2325. When a patient selects one of the show me tabs 2325, a video related to the corresponding what causes constipation information 2314a (e.g., stool moves too slowly through the colon, the colon takes too much water out of stools and pelvic floor muscles don't relax like normal, so stool doesn't pass easily, respectively).

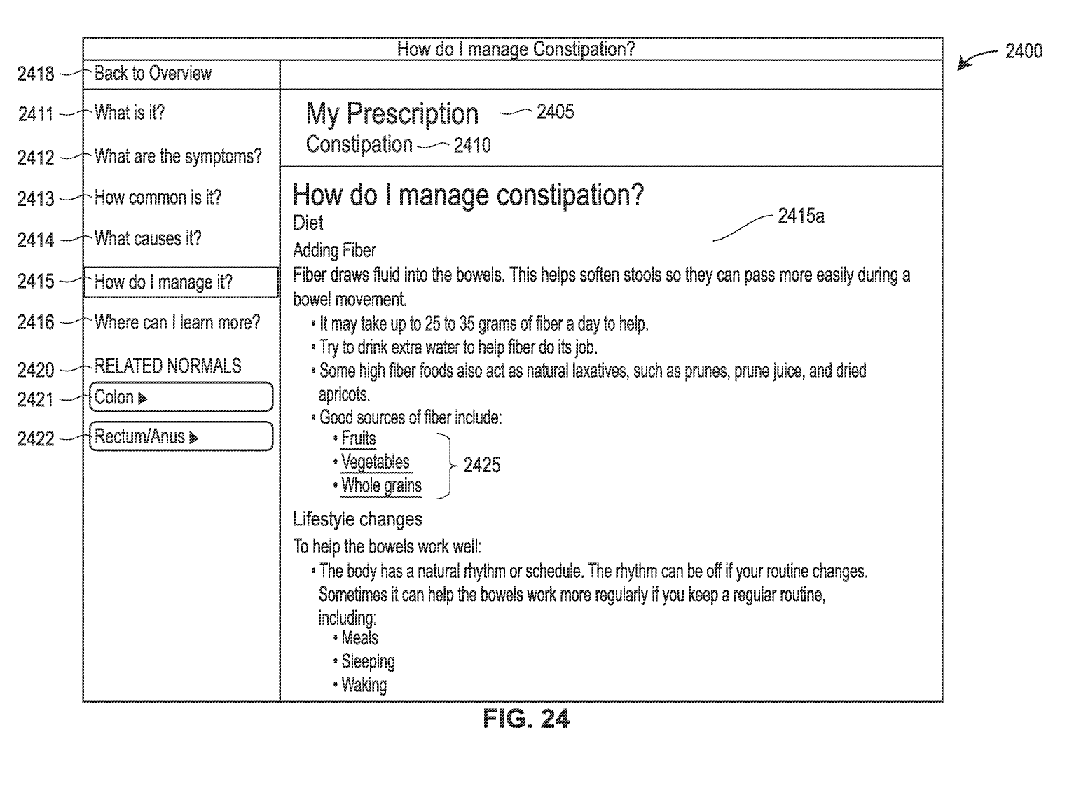

When a patient selects the how do I manage it selectable item 2315, 2415, the tenth tailored prescription user interface page 2400 of FIG. 24 may be displayed. The tenth tailored prescription user interface page 2400 may include a my prescription title 2405, a symptom title 2410 (e.g., constipation), a what is it selectable item 2411, a what are the symptoms selectable item 2412, a how common is it selectable item 2413, a what causes it selectable item 2414, how do I manage it 2415, a where can I learn more selectable item 2416 and may also include a back to overview button 2418. The tenth tailored prescription user interface page 2400 may also include a back to overview button 2415, a related normals section 2420, a colon tab 2421 and a rectum/anus tab 2422. When the patient selects the how do I manage it selectable item 2315, 2415, the how do I manage constipation information 2415a may also be displayed. The tenth tailored prescription user interface page 2400 may further include the good sources of fiber include selectable items 2425 (e.g., fruits, vegetables and whole grains). When a patient 105 selects one of the good sources of fiber including selectable items 2425, more information about the selected item may be displayed. The tenth tailored prescription user interface page 2400 may further include, as a patient scrolls down, recommended prescription and over the counter drug therapies (not shown). The over the counter drug therapies that may be listed on this user interface page 2400 may include psyllium, milk of magnesia, polyethylene glycol, bisacodyl and senna. Similarly, the prescription medications that may be listed on this user interface page 2400 may include lubiprostone and linaclotide (not shown).

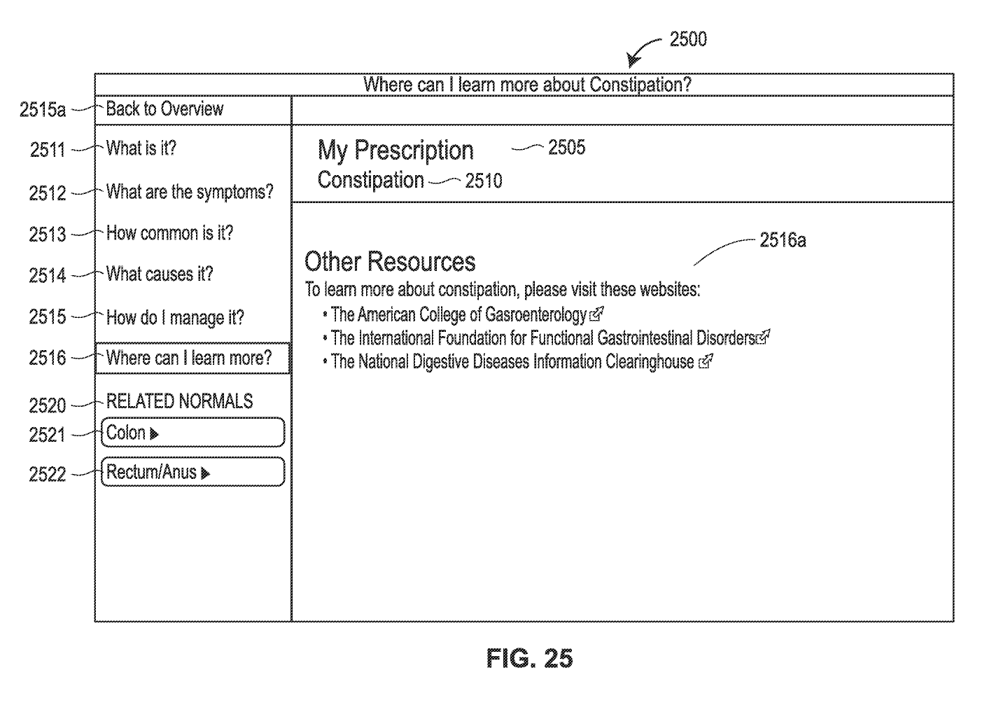

When a patient selects the where can I learn more selectable item 2416, 2516, the eleventh tailored prescription user interface page 2500 of FIG. 25 may be displayed. The eleventh tailored prescription user interface page 2500 may include a my prescription title 2505, a symptom title 2510 (e.g., constipation), a what is it selectable item 2511, a what are the symptoms selectable item 2512, a how common is it selectable item 2513, a what causes it selectable item 2514, how do I manage it 2515, a back to overview button 2515a and a where can I learn more selectable item 2516. The eleventh tailored prescription user interface page 2500 may also include a back to overview button 2515, a related normals section 2520, a colon tab 2521 and a rectum/anus tab 2522. When the patient selects the where can I learn more selectable item 2415, 2516, the other resources selectable items 2516a may also be displayed. When a patient 105 selects one of the other resources selectable items 2516a, more information about the selected item may be displayed.

Many additional selectable items can be incorporated, including, but not limited to, a what tests might be ordered selectable item. When the patient selects the what tests might be ordered selectable item, information regarding the possible tests a health provider may order to evaluate a user's symptoms may be displayed.

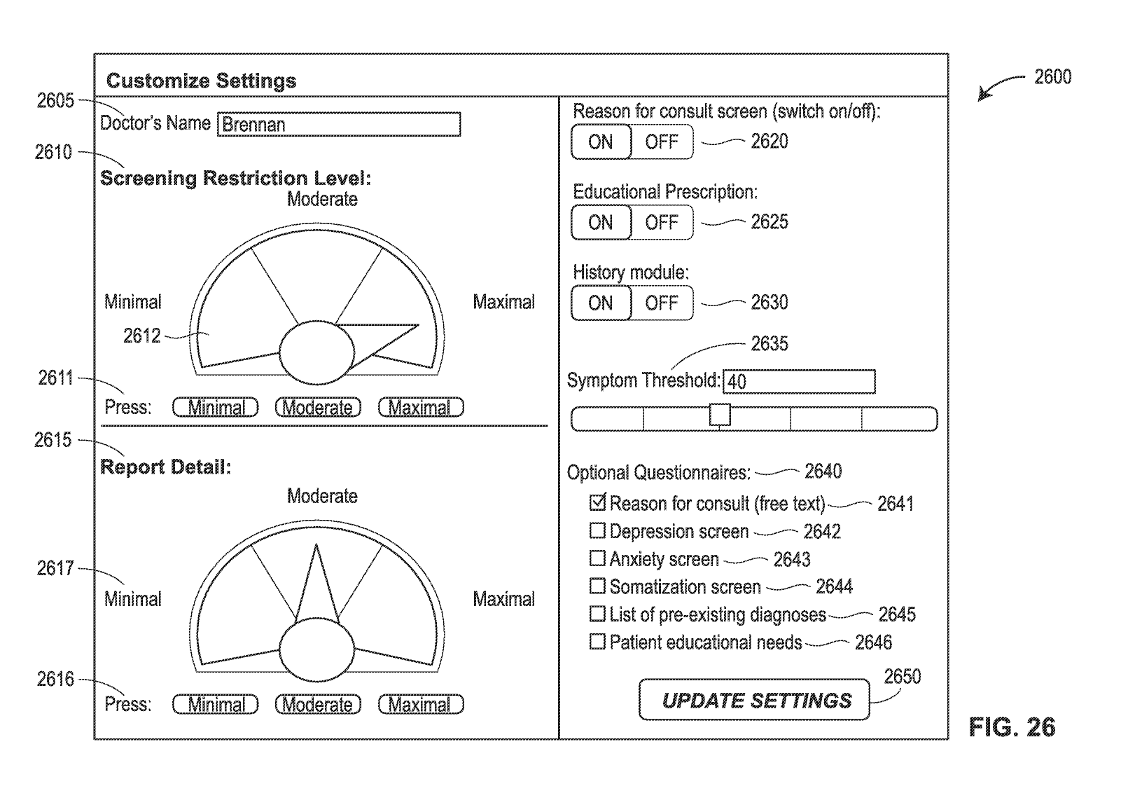

Turning to FIG. 26, an example customization user interface 2600 is depicted that may allow a physician to customize various aspects of a patient questionnaire 115, an integrated symptoms summary 120, a tailored prescription 125, a medical knowledge resource and medical educational materials, for example. The customization user interface 2600 may include a doctor's name entry box 2605, a screening restriction level section 2610 having screening restriction level selector buttons 2611 and a screening restriction level indicator 2612, a report detail section 2615 having a report detail selector buttons 2616 and a report detail indicator 2617, and an update settings selectable button 2650. The customization user interface 2600 may also include a reason for consult screen on/off switch 2620, an educational prescription on/off switch 2625, a history module on/off switch 2630, a symptom threshold setting entry box 2635 and an optional questionnaires section 2640. The reason for consult screen on/off switch 2620 may function to either include a consult screen within a patient questionnaire 115, an integrated symptoms summary 120 or a tailored prescription 125. The educational prescription on/off switch 2625 may function to preclude generation of a tailored prescription 125 in certain circumstances. The history module on/off switch 2630 may function to either include a history module within a patient questionnaire 115, an integrated symptoms summary 120 or a tailored prescription 125. Any one of the on/off switches 2620, 2625, 2630 may function to customize a patient's information different from a physician's information. An entry within the symptom threshold setting entry box 2635 may set the level of information provided to any given patient relative other patients included in the medical knowledge information, for example. Thereby, the information provided to any given patient is correlated with other similarly situated patients. The optional questionnaires section 2640 may include a reasons for consult (free text) selection 2641, a depression screen selection 2642, an anxiety screen selection 2643, a somatization screen selection 2644, a list of pre-existing diagnoses selection 2645 and a patient educational needs selection 2646.

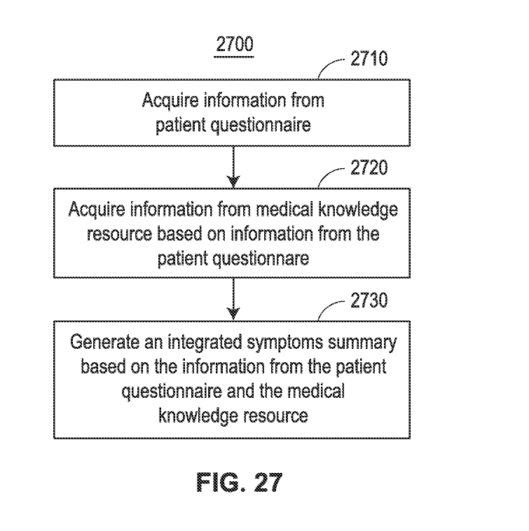

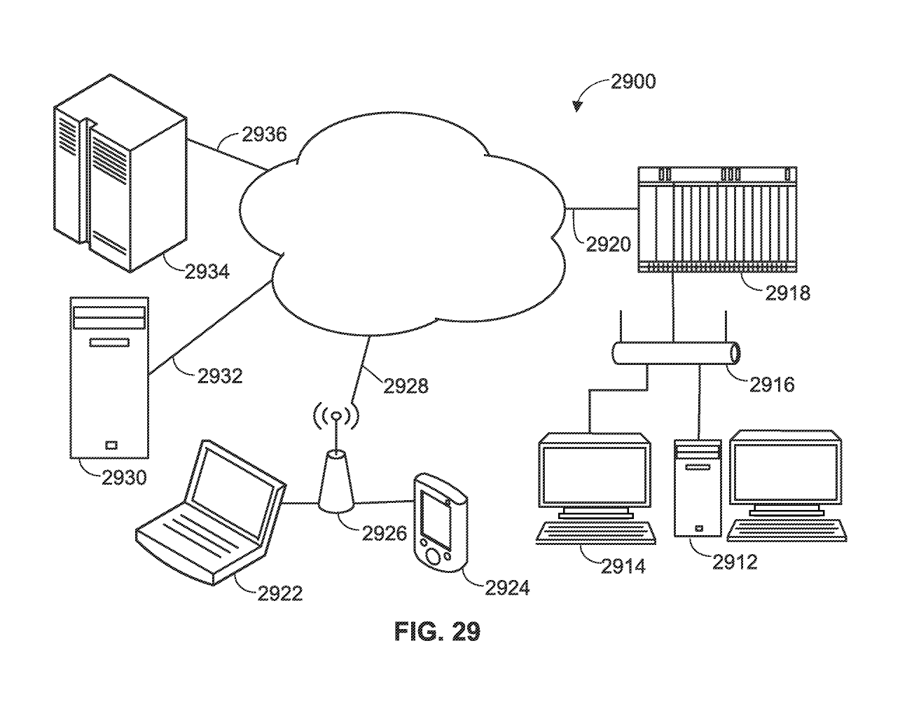

FIG. 27 illustrates a block diagram of an exemplary computer-implemented method 2700 for generating an integrated symptoms summary 120. The method 2700 may be implemented by executing associated computer-readable instructions by a suitable computing device (e.g., mainframe 2934 of FIG. 29). The computing device 2934 may acquire information from a patient questionnaire 115 (block 2710). The computing device 2934 may acquire information from a medical knowledge resource based on the information from the patient questionnaire 115 (block 2720). The computing device 2934 may generate an integrated symptoms summary 120 based on the information from the patient questionnaire 115 and the medical knowledge resource information (block 2730).

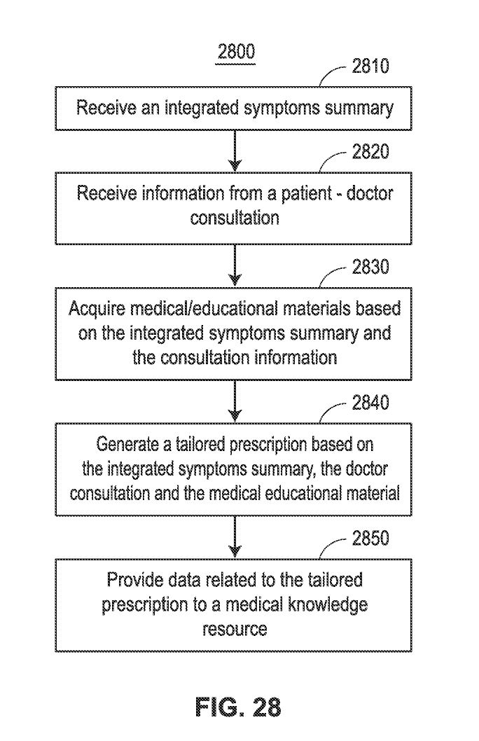

With reference to FIG. 28, a block diagram of exemplary computer-implemented method 2800 is illustrated for automatically evaluating medical symptoms and providing a tailored prescription 135. The method 2800 may be implemented by executing associated computer-readable instructions by a suitable computing device (e.g., mainframe 2934 of FIG. 29). The computing device 2934 may receive an integrated symptoms summary 115 (block 2810). The computing device 2934 may receive information from a patient-doctor consultation 130 (block 2820). The computing device 2934 may acquire medical educational materials based on the integrated symptoms summary 115 and the consultation information 130 (block 2830). The computing device 2934 may generate a tailored prescription 135 based on the integrated symptoms summary 115, the doctor consultation 130 and the medical educational material (block 2840). The computing device 2934 may provide data related to the tailored prescription 135 to a medical knowledge resource (block 2850).

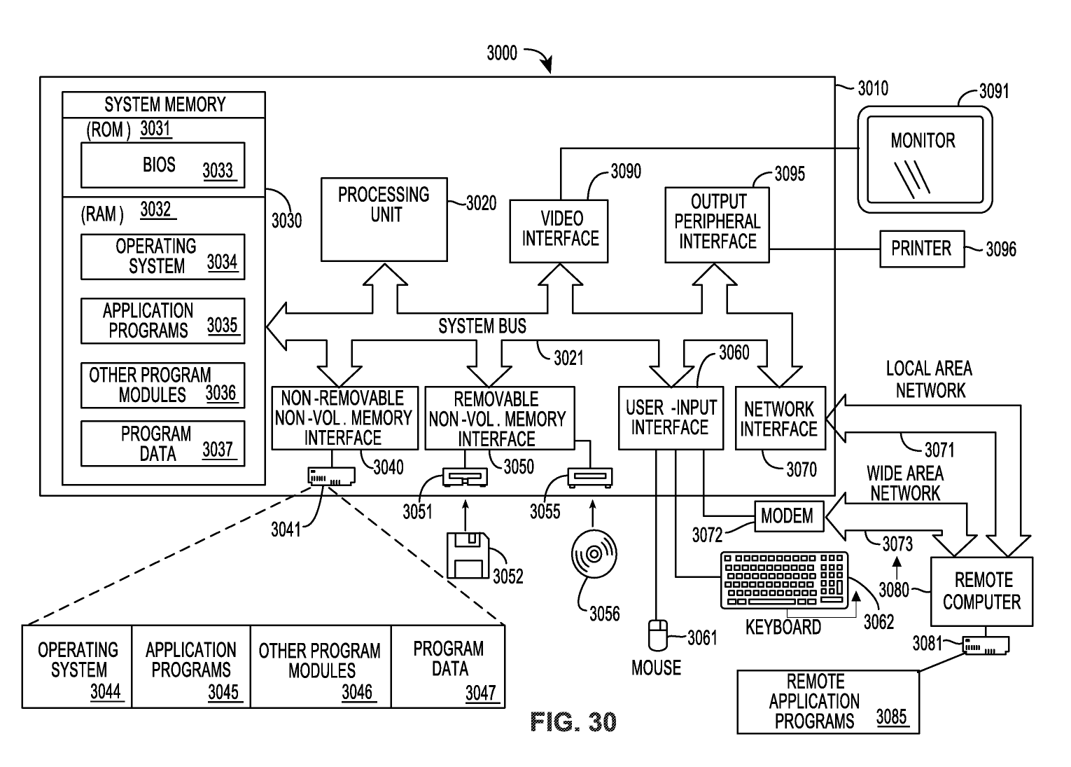

Automatically evaluating medical symptoms and providing a tailored prescription may be performed using an electronic system. FIG. 29 and FIG. 30 provide an exemplary structural basis for the network and data manipulation platforms related to such a system.

FIG. 29 illustrates an exemplary block diagram of a network 2900 and computer hardware that may be utilized in an exemplary system for automatically evaluating medical symptoms and providing a tailored prescription in accordance with the described embodiments. The network 2900 may be the Internet, a virtual private network (VPN), or any other network that allows one or more computers, communication devices, databases, etc., to be communicatively connected to each other. The network 2900 may be connected to a personal computer 2912, and a computer terminal 2914 via an Ethernet 2916 and a router 2918, and a landline 2920. The Ethernet 2916 may be a subnet of a larger Internet Protocol network. Other networked resources, such as projectors or printers (not depicted), may also be supported via the Ethernet 2916 or another data network. Additionally, the network 2900 may be wirelessly connected to a laptop computer 2922 and a personal data assistant 2924 via a wireless communication station 2926 and a wireless link 2928. Similarly, a server 2930 may be connected to the network 2900 using a communication link 2932 and a mainframe 2934 may be connected to the network 2900 using another communication link 2936. The server 2930 may include a memory that stores a medical knowledge resource database and/or a medical education information database. The medical knowledge resource database may include data representative of various symptoms, diagnosis and care plans for various medical conditions, such as GI conditions for example. The medical education information database may include data representative of educational information related to various medical conditions (e.g., GI conditions), various prescription medications, various medical condition care plans, the human anatomy, functions of various organs within the human body, etc. The network 2900 may be useful for supporting peer-to-peer network traffic. The patient's questionnaire information may also be received from a remotely-accessible, free-standing memory device (not shown) on the network 2900. In some embodiments, the patient's monitored neurological information may be received by more than one computer. In other embodiments, the patient questionnaire information may be received from more than one computer and/or remotely-accessible memory device.

Some or all calculations performed in automatically evaluating medical symptoms and providing a tailored prescription described above may be performed by a computer such as the personal computer 2912, laptop computer 2922, server 2930, mainframe 2934 or a remote cloud of computers, for example. In some embodiments, some or all of the determinations, data manipulation and comparisons may be performed by more than one computer.

Automatically evaluating medical symptoms and providing a tailored prescription as described above in the embodiments may also be performed by a computer such as the personal computer 2912, laptop computer 2922, server 2930 or mainframe 2934, for example. The indications may be made by setting the value of a data field, for example. In some embodiments, indicating a level of consciousness may include sending data over a network such as network 2900 to another computing device.

FIG. 30 illustrates an exemplary block diagram of a system 3000 on which an exemplary method for automatically evaluating medical symptoms and providing a tailored prescription may operate in accordance with the described embodiments. The system 3000 of FIG. 30 includes a computing device in the form of a computer 3010. Components of the computer 3010 may include, and are not limited to, a processing unit 3020, a system memory 3030, and a system bus 3021 that couples various system components including the system memory to the processing unit 3020. The system bus 3021 may be any of several types of bus structures including a memory bus or memory controller, a peripheral bus, and a local bus using any of a variety of bus architectures. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The computer 3010 typically includes a variety of computer readable media. Computer readable media can be any available media that can be accessed by computer 3010 and includes both volatile and nonvolatile media, and both removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 3010. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above are also included within the scope of computer readable media.

The system memory 3030 includes computer storage media in the form of volatile and/or nonvolatile memory such as read only memory (ROM) 3031 and random access memory (RAM) 3032. A basic input/output system 3033 (BIOS), containing the basic routines that help to transfer information between elements within computer 3010, such as during start-up, is typically stored in ROM 3031. RAM 3032 typically contains data and/or program modules or routines, e.g., analyzing, calculating, indicating, etc., that are immediately accessible to and/or presently being operated on by processing unit 3020. By way of example, and not limitation, FIG. 30 illustrates operating system 3034, application programs 3035, other program modules 3036, and program data 3037.

The computer 3010 may also include other removable/non-removable, volatile/nonvolatile computer storage media. By way of example only, FIG. 30 illustrates a hard disk drive 3041 that reads from or writes to non-removable, nonvolatile magnetic media, a magnetic disk drive 3051 that reads from or writes to a removable, nonvolatile magnetic disk 3052, and an optical disk drive 3055 that reads from or writes to a removable, nonvolatile optical disk 3056 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 3041 is typically connected to the system bus 3021 through a non-removable memory interface such as interface 3040, and magnetic disk drive 3051 and optical disk drive 3055 are typically connected to the system bus 3021 by a removable memory interface, such as interface 3050.

The drives and their associated computer storage media discussed above and illustrated in FIG. 30 provide storage of computer readable instructions, data structures, program modules and other data for the computer 3010. In FIG. 30, for example, hard disk drive 3041 is illustrated as storing operating system 3044, application programs 3045, other program modules 3046, and program data 3047. Note that these components can either be the same as or different from operating system 3034, application programs 3035, other program modules 3036, and program data 3037. Operating system 3044, application programs 3045, other program modules 3046, and program data 3047 are given different numbers here to illustrate that, at a minimum, they are different copies. A user may enter commands and information into the computer 3010 through input devices such as a keyboard 3062 and cursor control device 3061, commonly referred to as a mouse, trackball or touch pad. A screen 3091 or other type of display device is also connected to the system bus 3021 via an interface, such as a graphics controller 3090. In addition to the screen 3091, computers may also include other peripheral output devices such as printer 3096, which may be connected through an output peripheral interface 3095.

The computer 3010 may operate in a networked environment using logical connections to one or more remote computers, such as a remote computer 3080. The remote computer 3080 may be configured as a patient user interface. The logical connections depicted in FIG. 30 include a local area network (LAN) 3071 and a wide area network (WAN) 3073, but may also include other networks. Such networking environments are commonplace in hospitals, offices, enterprise-wide computer networks, intranets, and the Internet.

When used in a LAN networking environment, the computer 3010 is connected to the LAN 3071 through a network interface or adapter 3070. When used in a WAN networking environment, the computer 3010 typically includes a modem 3072 or other means for establishing communications over the WAN 3073, such as the Internet. The modem 3072, which may be internal or external, may be connected to the system bus 3021 via the input interface 3060, or other appropriate mechanism. In a networked environment, program modules depicted relative to the computer 3010, or portions thereof, may be stored in the remote memory storage device 3081. By way of example, and not limitation, FIG. 30 illustrates remote application programs 3085 as residing on memory device 3081.

The communications connections 3070, 3072 allow the device to communicate with other devices. The communications connections 3070, 3072 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

The embodiments for the methods of automatically evaluating medical symptoms and providing tailored prescriptions described above may be implemented in part or in their entirety using one or more computer systems such as the computer system 3000 illustrated in FIG. 30. The data representative of the information regarding the symptoms, data representative of the information related to the medical condition and data representative of the physician consultation information, database, and/or models may be received by a computer such as the computer 3010, for example. The data representative of the information regarding the symptoms, data representative of the information related to the medical condition and data representative of the physician consultation information, database, and/or models may be received over a communication medium such as local area network 3071 or wide area network 3073, via network interface 3070 or user-input interface 3060, for example. As another example, the data representative of the information regarding the symptoms, data representative of the information related to the medical condition and data representative of the physician consultation information, database, and/or models may be received from a remote source such as the remote computer 3080 where the data is initially stored on memory device such as the memory storage device 3081. As another example, the data representative of the information regarding the symptoms, data representative of the information related to the medical condition and data representative of the physician consultation information, database, and/or models may be received from a removable memory source such as the nonvolatile magnetic disk 3052 or the nonvolatile optical disk 3056. As another example, the data representative of the information regarding the symptoms, data representative of the information related to the medical condition and data representative of the physician consultation information, database, and/or models may be received as a result of a human entering data through an input device such as the keyboard 3062.

Some or all analyzing or calculating performed in the determination of a tailored prescription described above (e.g., receiving and analyzing data representative of the information regarding the symptoms, data representative of the information related to the medical condition and data representative of the physician consultation information) may be performed by a computer such as the computer 3010, and more specifically may be performed by one or more processors, such as the processing unit 3020, for example. In some embodiments, some calculations may be performed by a first computer such as the computer 3010 while other calculations may be performed by one or more other computers such as the remote computer 3080. The analyses and/or calculations may be performed according to instructions that are part of a program such as the application programs 3035, the application programs 3045 and/or the remote application programs 3085, for example.

Determining a tailored prescription as described above in the embodiments may also be performed by a computer such as the computer 3010. The indications may be made by setting the value of a data field stored in the ROM memory 3031 and/or the RAM memory 3032, for example. In some embodiments, providing an integrated symptom summary to a physician and providing a tailored prescription to a patient may include sending data over a network such as the local area network 3071 or the wide area network 3073 to another computer, such as the remote computer 3081. In other embodiments, providing an integrated symptom summary to a physician and providing a tailored prescription to a patient may include sending data over a video interface such as the video interface 3090 to display information relating to the prediction on an output device such as the screen 3091 or the printer 3096, for example.

The systems and methods of the present disclosure may provide computerized provider order entry (CPOE), E-Prescribing (eRx), report ambulatory clinical quality measures to CMS/States, implement one clinical decision support rule, provide patients with an electronic copy of their health information, upon request, provide clinical summaries for patients for each office visit, drug-drug and drug-allergy interaction checks, record demographics, maintain an up-to-date problem list of current and active diagnoses, maintain active medication list, maintain active medication allergy list, record and chart changes in vital signs, record smoking status for patients 13 years or older and capability to exchange key clinical information among providers of care and patient-authorized entities electronically.

The disclosed systems and methods may provide drug-formulary checks, incorporate clinical lab test results as structured data, generate lists of patients by specific conditions, send reminders to patients per patient preference for preventive/follow up care, provide patients with timely electronic access to their health information, use certified EHR technology to identify patient-specific education resources and provide to patient, if appropriate, medication reconciliation, summary of care record for each transition of care/referrals, capability to submit electronic data to immunization registries/systems and capability to provide electronic syndromic surveillance data to public health agencies.

The systems and methods of the present disclosure may use computerized provider order entry (CPOE) for medication, laboratory and radiology orders generate and transmit permissible prescriptions electronically (eRx), record demographic information, record and chart changes in vital signs, record smoking status for patients 13 years old or older, use clinical decision support to improve performance on high-priority health conditions, provide patients the ability to view online, download and transmit their health information, provide clinical summaries for patients for each office visit, protect electronic health information created or maintained by the Certified EHR Technology, incorporate clinical lab-test results into Certified EHR Technology, generate lists of patients by specific conditions to use for quality improvement, reduction of disparities, research, or outreach, use clinically relevant information to identify patients who should receive reminders for preventive/follow-up care, use certified EHR technology to identify patient-specific education resources, perform medication reconciliation, provide summary of care record for each transition of care or referral, submit electronic data to immunization registries and use secure electronic messaging to communicate with patients on relevant health information.

The disclosed system and methods may also include a feature that allows a user to identify a local health care provider that can assist in the evaluation and management of their GI or other symptoms. Algorithms will allow the matching of a user to a provider in his/her local area. This feature will take advantage of existing relationships with reputable professional organizations, existing commercial entities, or the feature may include an opt in feature, which will allow health care providers to participate in the system.

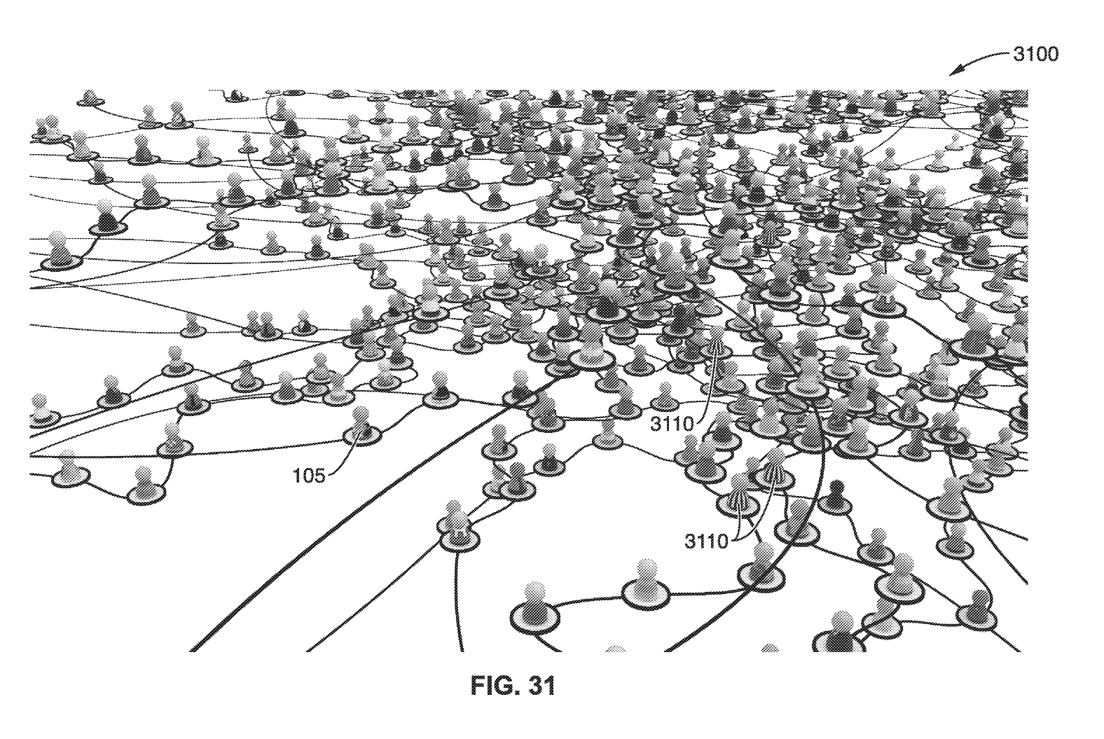

The disclosed systems and methods may also include a feature that allows tight patient matching across a wide range of variables. Referring to FIG. 31, this multi-dimensional matching feature 3100 may be used to create unique groups 3110 of patients 105 whose GI symptoms closely resemble one another. These groups 3110 can then connect online using secure social media outlets. This multi-dimensional matching feature 3100 may be used broadly for many different disease states.

The multi-dimensional matching feature 3100 may provide an algorithm that allows users to identify other users with very similar symptom experiences. The multi-dimensional matching algorithm can improve upon current approaches to connecting patients with similar symptom experiences. These current approaches work by allowing patients to identify one another through searches of self-reported diseases and are not based on multi-dimensional matching.

In one embodiment of the multi-dimensional matching feature 3100, two types of information may be used: (1) data representative of a medical patient questionnaire information, such as the symptom scores 925a shown in FIG. 9A, and (2) the information collected in the history of presenting illness (HPI) section 1010 of the integrated symptoms summary 1000 shown in FIG. 10.

The multi-dimensional matching feature 3100 can use the data representative of a medical patient questionnaire information by first, detecting which symptoms the user identifies, such as those found in a symptom report similar to the GI symptom report 910a shown in FIG. 9A. Each of the identified symptoms are measured according to severity and scored using a 0-100 scale, which corresponds to a percentile ranking as compared to the U.S. population. Examples of these symptom scores are shown in the symptom score section 925a of FIG. 9A. These scores may be further categorized into one of five levels, including, for example, “no symptoms” as the lowest severity level, and then for those with symptoms, “least symptomatic” as the 0-25^{th} percentile, “mildly symptomatic” as the 26-50^{th} percentile, “moderately symptomatic” as the 51-75^{th} percentile and “most symptomatic” as the 76-100^{th} percentile. These four quartiles (0-25, 26-50, 51-75 and 76-100) may then be illustrated using a heat map that visually demonstrates the symptom profile of each user. An example of a symptom profile heat map is the symptom tracker 900b heat map shown in FIG. 9B. Each of the four quartiles are represented as different bands 910b on the heat map, with the “no symptoms” category also represented as a band at the lowest end of the heat map. The multi-dimensional matching algorithm can calculate a score based on the user's symptom profile using look-up tables and each user may be categorized across the symptoms used for that particular matching. For example, the user could be categorized across the 8 symptoms listed on the GI symptom report 910a shown in FIG. 9A. This information can then be used to match users who share the same symptoms and fall within the same heat map band 910b for those symptoms.

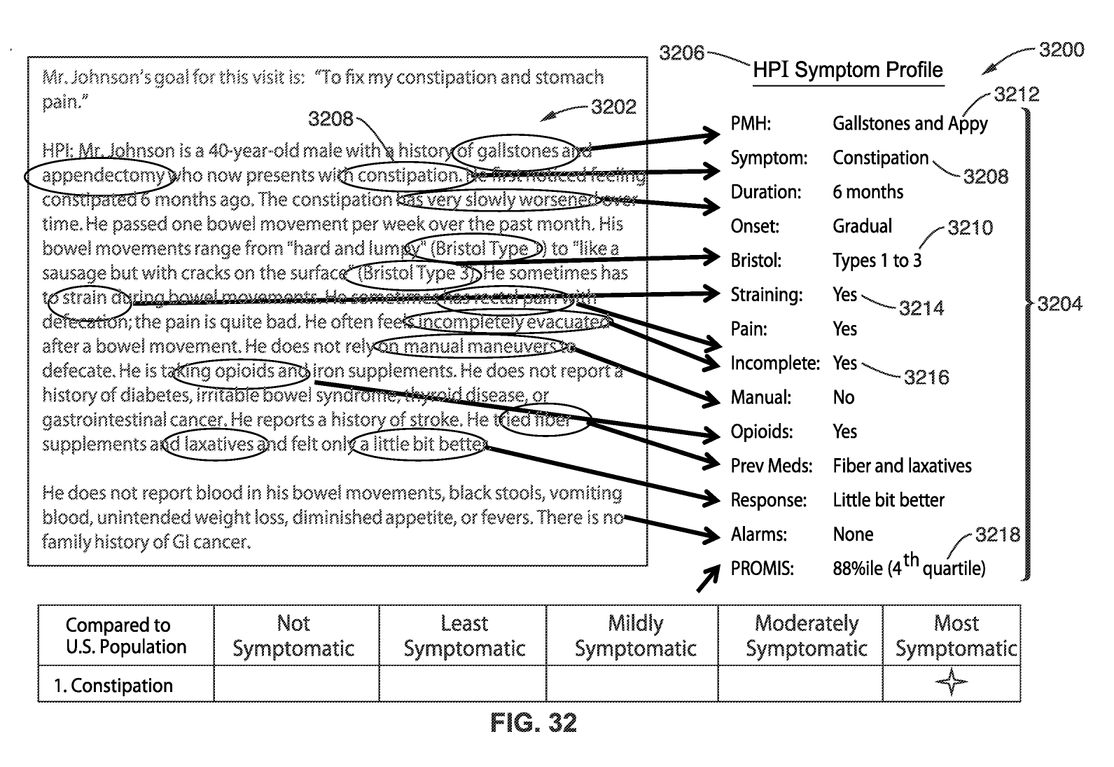

Referring to FIG. 32, an illustration 3200 of how the information from the user's HPI 3202 may also be used by the multi-dimensional matching feature 3100 is shown. The HPI 3202 may provide a specific user symptom profile 3206 from over 100 symptom variables 3204. For example, if a patient has abdominal pain, the matching feature may measure the location, severity, timing, frequency, bothersomeness, impact, aggravators and alleviators of pain, among other factors. Similarly, if a patient has constipation 3208, the feature may measure the frequency and form of bowel movements 3210, presence of concurrent symptoms 3012, straining 3014, incomplete evacuation 3016, and score based on the user's initial symptom profile 3018. The matching feature can make similar measurements for each of the remaining symptoms.

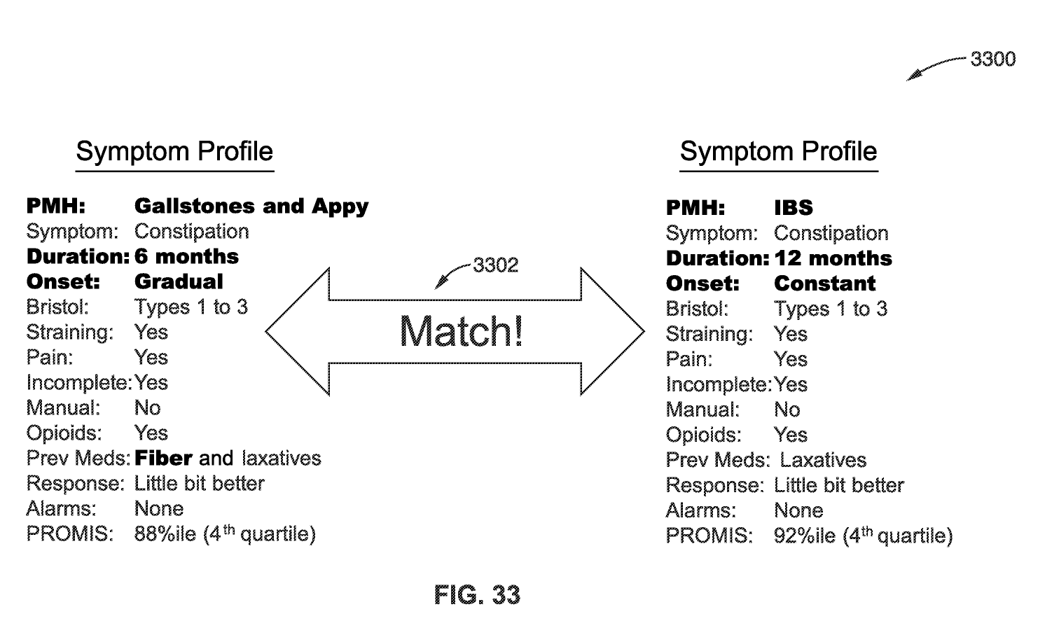

Referring to FIG. 33, the multi-dimensional matching algorithm can then evaluate the matching user responses 3300 given in the initial symptom profile and in the HPI and match patients 3302 who have provided similar symptoms for at least 50% of the variables. Patients may then connect with one another and share information if they choose.

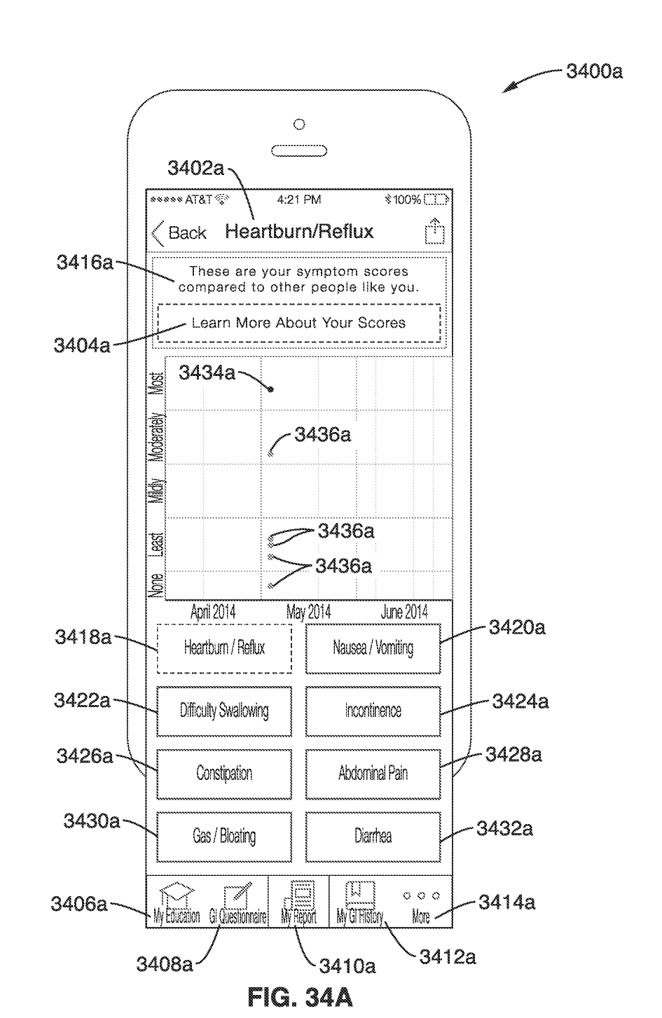

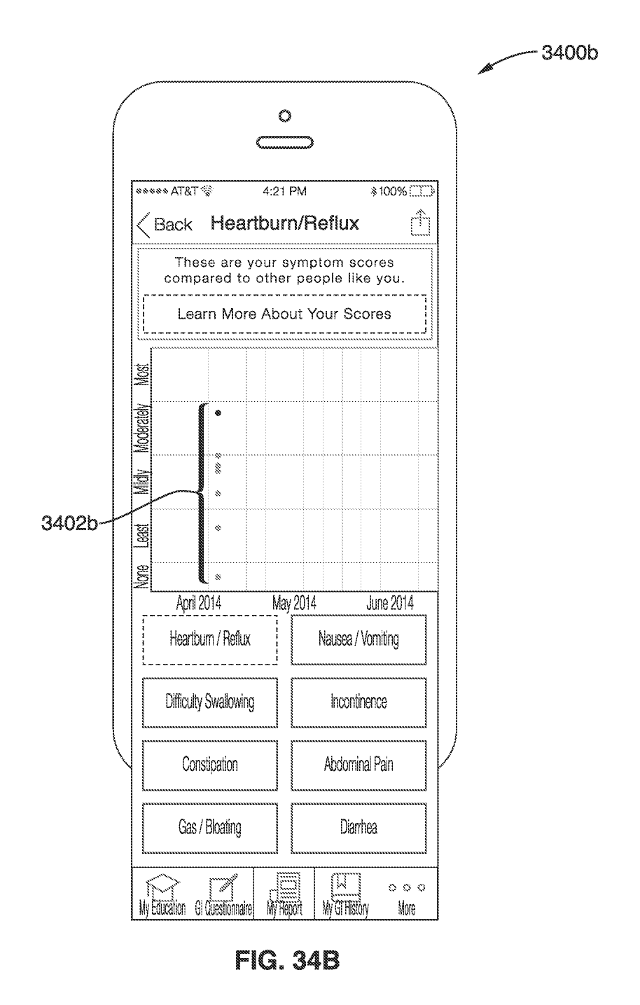

It will be appreciated that the system and methods described herein can be implemented using any type of user device. Although the software and methods shown in FIG. 34 through FIG. 41 are particularly beneficial for use with mobile devices such as smart phones and tablets, it is also contemplated that the software and methods of FIG. 34 through FIG. 41 may also be implemented on any computing device, e.g. a laptop or desktop computer. Similarly, although the system and methods previously described were illustrated by way of a personal computer, the software and techniques may also be used on any platform, such as a smartphone or tablet or other mobile device.

The disclosed system and methods may also include a feature that allows patients, especially those who suffer from chronic symptoms, to monitor their symptoms over time. Symptom monitoring can provide insight into whether treatments are working or not and whether a patient's condition is changing over time. The symptom monitoring feature can provide specific information about the significance of changes in symptoms and symptom severity identified by the patient. The symptom monitoring feature may also provide a visualization that can illustrate to the patient and health care providers whether symptoms are improving, worsening, or remaining the same. The feature may also indicate whether dynamic changes are clinically meaningful.

FIG. 34 through FIG. 41 illustrate how a user might monitor their symptoms or how a health care provider might monitor a patient's symptoms using the symptom monitoring feature via an application on a mobile device. Referring to FIG. 34A, an initial user interface screen 3400a is shown depicting baseline symptom scores for multiple symptoms reported by a patient. This initial user interface screen 3400a may include a symptom heading 3402a to identify the selected symptom, a learn more about your scores tab 3404a, a my education tab 3406a, a GI questionnaire tab 3408a, a my report tab 3410a, a my GI history tab 3412a and any other helpful tabs, which may be displayed when a more tab 3414a is selected by a user. The user may also choose to display their scores as compared to other people with similar symptom profiles 3416a. When the user locates the symptom of greatest interest and selects the corresponding tab, the selected symptom tab may become highlighted in bold colors or tones (shown here as a dashed box), whereas the other symptom tabs may be shown in muted colors or tones (shown here as a solid box). In the example illustrated in FIG. 34A, the Heartburn/Reflux tab 3418a has been selected, as indicated by the dashed box. The dashed box in this diagram represents bold colors or tones that might be used in practice. By contrast, the symptoms that have not been selected 3420a, 3422a, 3424a, 3426a, 3428a, 3430a, 3432a are shown having a solid box. The solid box in this diagram represents muted colors or tones that might be used in practice. As each individual symptom tab is selected, that symptom tab takes its turn as the predominant symptom tab and may be displayed in full color or tone. Similarly, the point which corresponds to the selected symptom 3434a may also be shown in a dark or bold color, while the other symptoms are shown as points 3436a in muted colors or tones.

Referring to FIG. 34B, the user may also choose to display a user interface screen 3400b with symptoms previously reported 3402b.

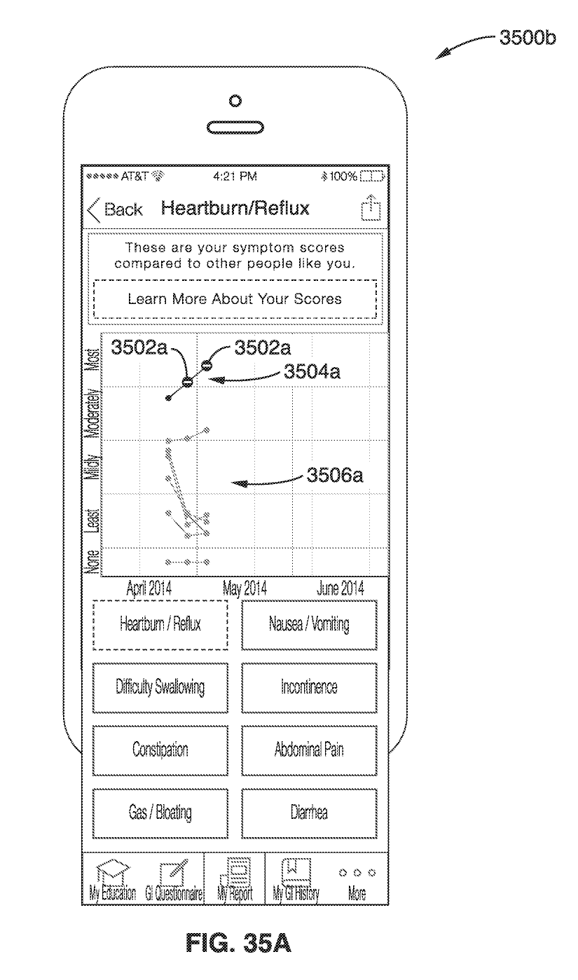

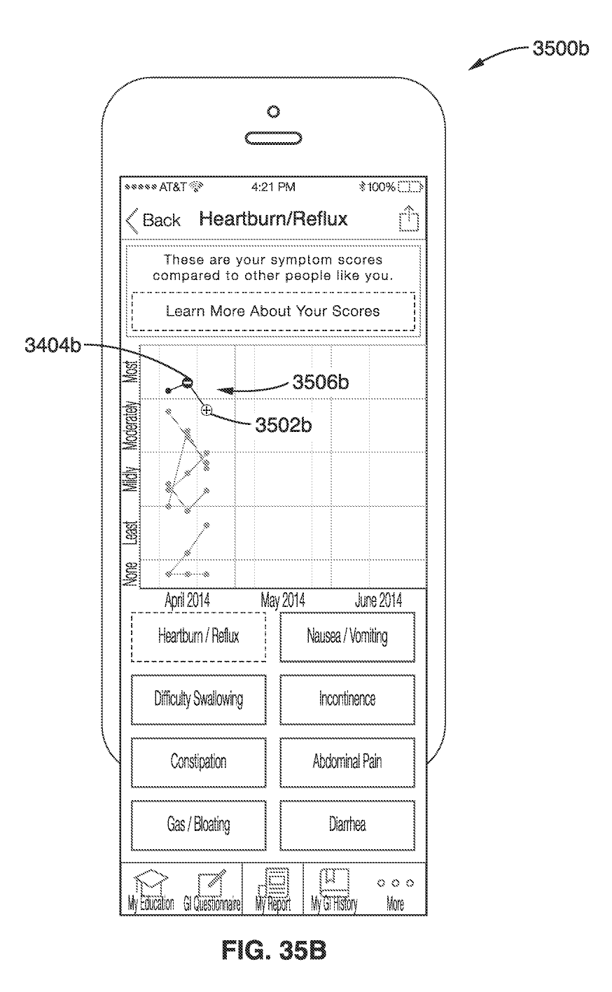

Referring to FIG. 35A, as the user logs additional symptoms 3502a and generates additional symptom reports, the application may display a user interface screen 3500a illustrating symptom changes over time using a line graph 3504a function. Again, the line graph 3504a for the symptom of greatest interest may be shown in bold colors or tones, whereas the line graphs for the other symptoms 3506a may be shown in muted colors or tones. Referring to FIG. 35B, the symptom monitoring feature can display a user interface screen 3500b that can alert a user to a change in their symptoms that may be important. This may be done by displaying “+” 3502b and “−” 3504b signs. For example, if a change in the user's symptom exceeds a minimally clinically important difference (MCID), then a “+” 3502b sign or a “−” 3504b sign may appear in the line graph 3506b. This “+” 3502b or “−” 3504b sign may indicate to the user or health care provider that the symptom change meets a pre-determined MCID threshold. The MCID may be set through standard psychometric principles. For instance, if empirical data indicate that the MCID on a 0-100 point scale for heartburn is five, then any change equal to or exceeding five points (over time) is considered clinically important. If the change is greater than five points, then this may be interpreted to mean that a positive (“+”) change has occurred and if the change is less than five points, then this may be interpreted to mean that a negative (“−”) change has occurred. Conversely, if the change is plus or minus four points (over time), the change may be considered statistical noise and may not be considered clinically important. Therefore, the symptom monitoring feature can distinguish important symptom changes from noise and display “+” 3502b and “−” 3504b signs embedded in the line graph 3506b, as shown in FIG. 35B. The symptom monitoring feature can provide specific guidance to the user, and may explain whether trends in the data are clinically important or not.

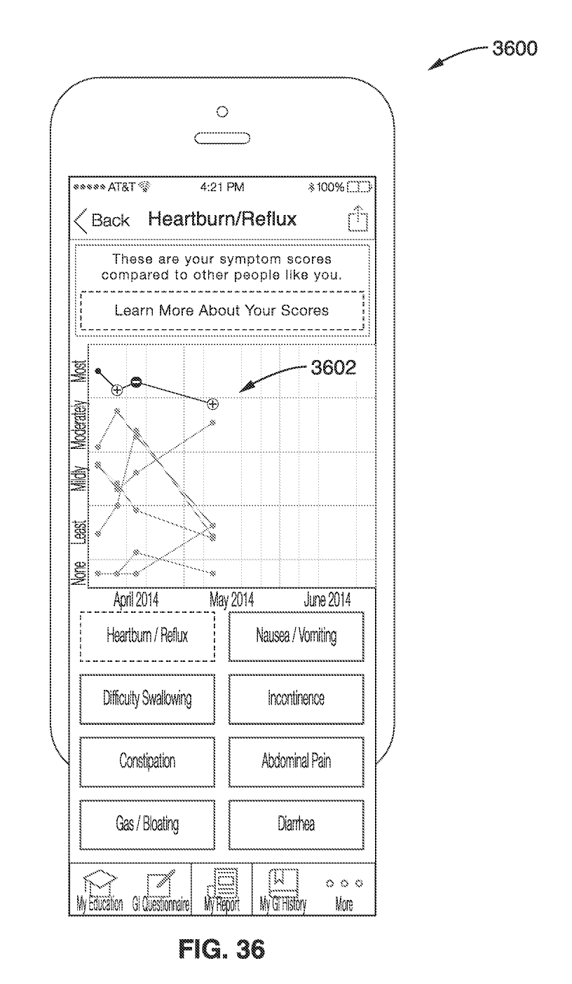

FIG. 36 shows a user interface screen 3600 that displays symptom monitoring line graphs 3602 with breaks in symptom reporting. In this example, this is what the symptom line graphs 3602 may look like if the user had missed entering a symptom during a week or several weeks.

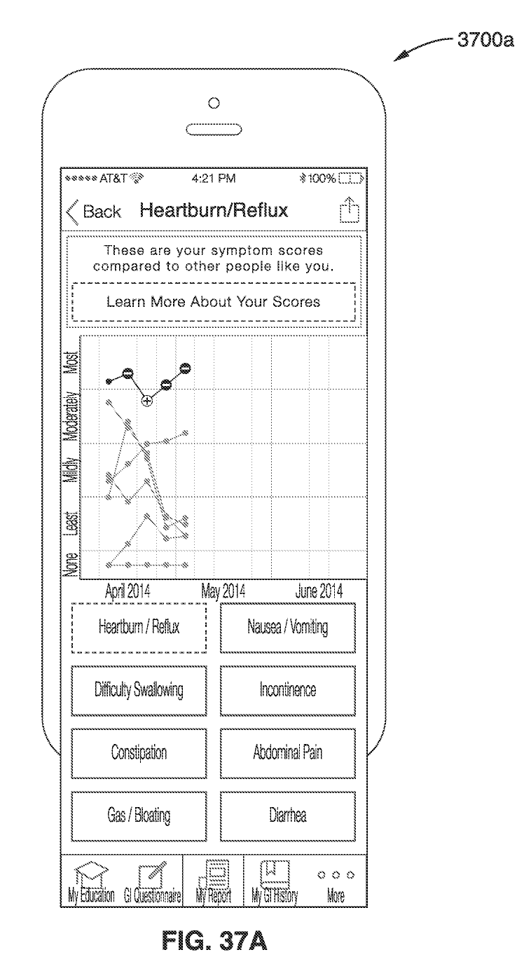

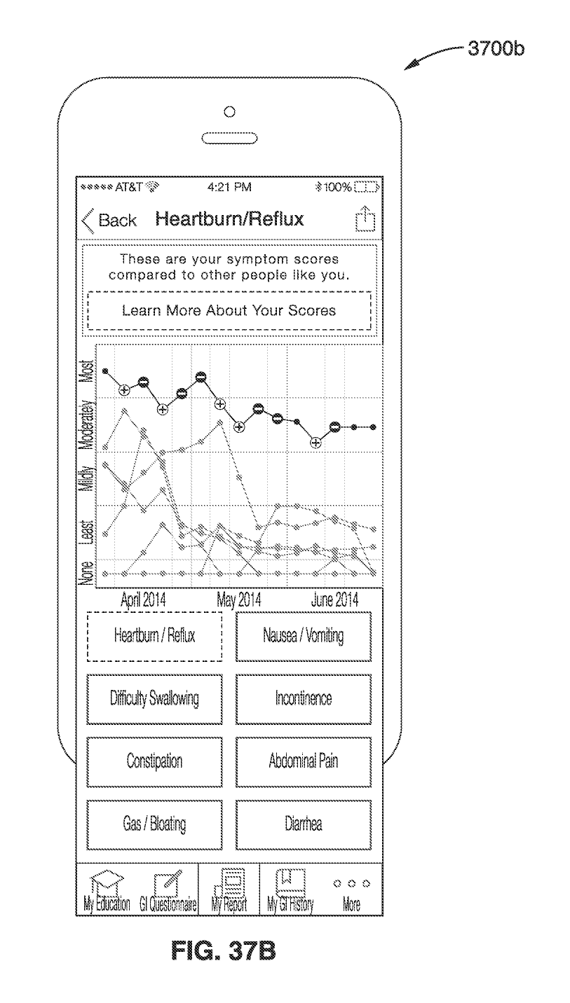

FIG. 37A and FIG. 37B show user interface screens 3700a, 3700b with symptom line graphs after five symptom entries have been made and after fifteen symptom entries have been made, respectively.

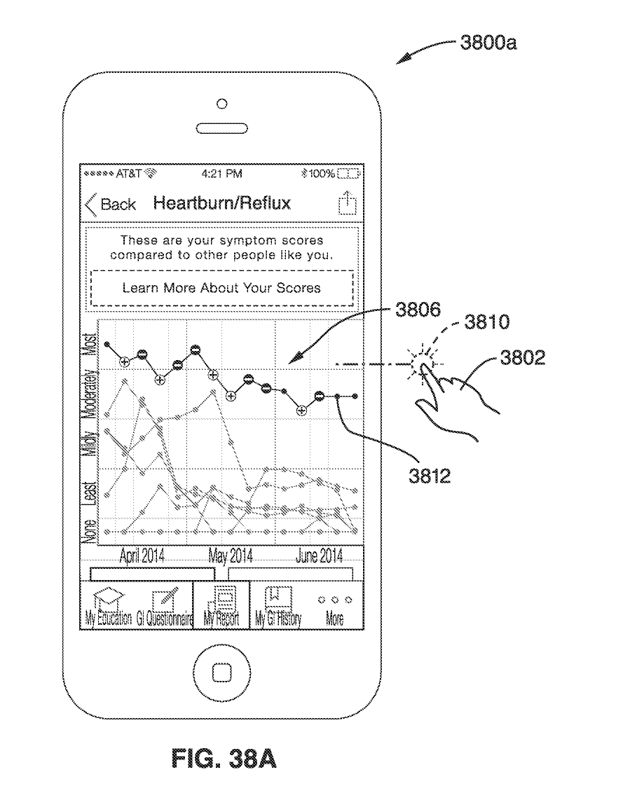

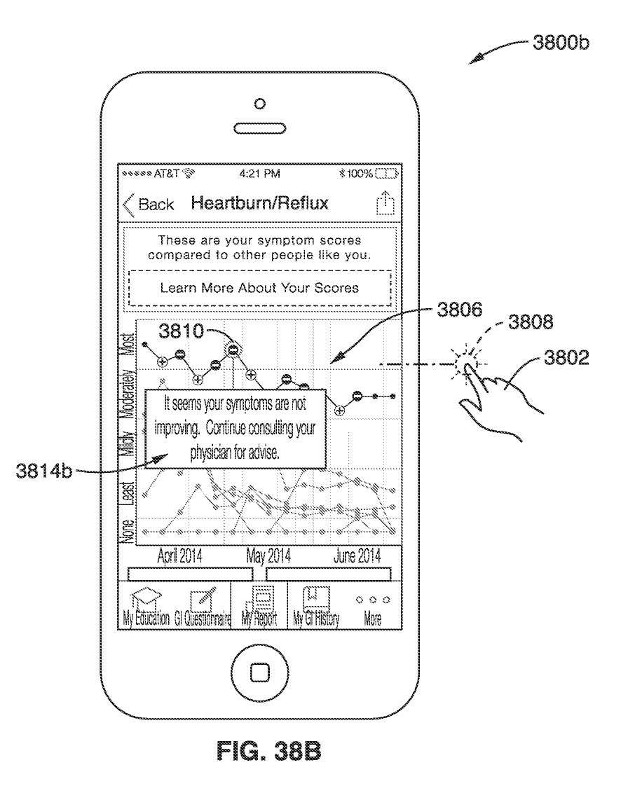

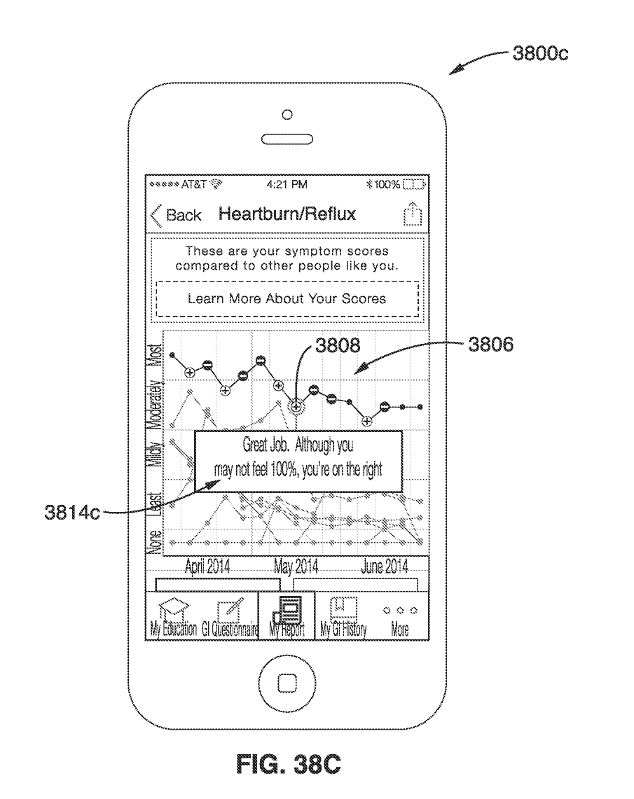

FIG. 38A through FIG. 38C show user interface screens 3800a, 3800b, 3800c illustrating how a user 3802 may cause information to be displayed regarding a specific point on the selected symptom line graph by selecting that point on the symptom line graph 3806. For example, the selected line on the graph may show a positive sign (“+”) 3808 on a point (see FIG. 38C) if there was a minimally clinically important positive difference from the previous point and the selected line on the graph may show a negative sign (“−”) 3810 on a point (see FIG. 38B) if there was a minimally clinically important negative difference from the previous point. If there was no significant positive or negative change then just a point may be displayed 3812. When a user 3802 selects a negative point (“−”) 3810 on the graph, the user may see a pop-up 3814b that displays information reflecting the negative point (“−”) 3810, as shown in FIG. 38B. Similarly, when a user 3802 selects a positive point (“+”) 3808 on the graph, the user may see a pop-up 3814c that displays information reflecting the positive point (“+”) 3808, as shown in FIG. 38C.

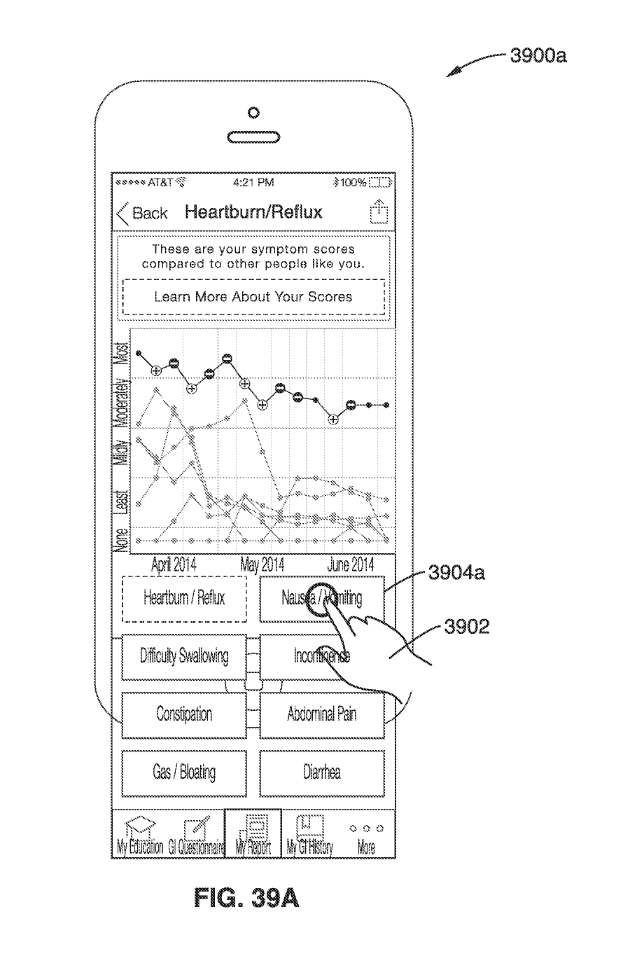

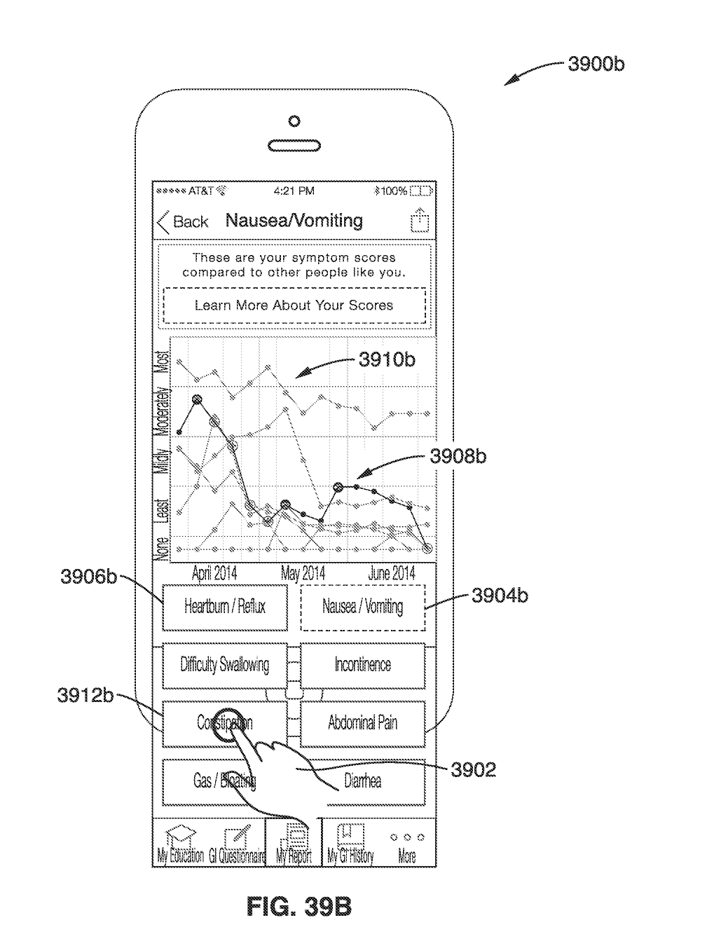

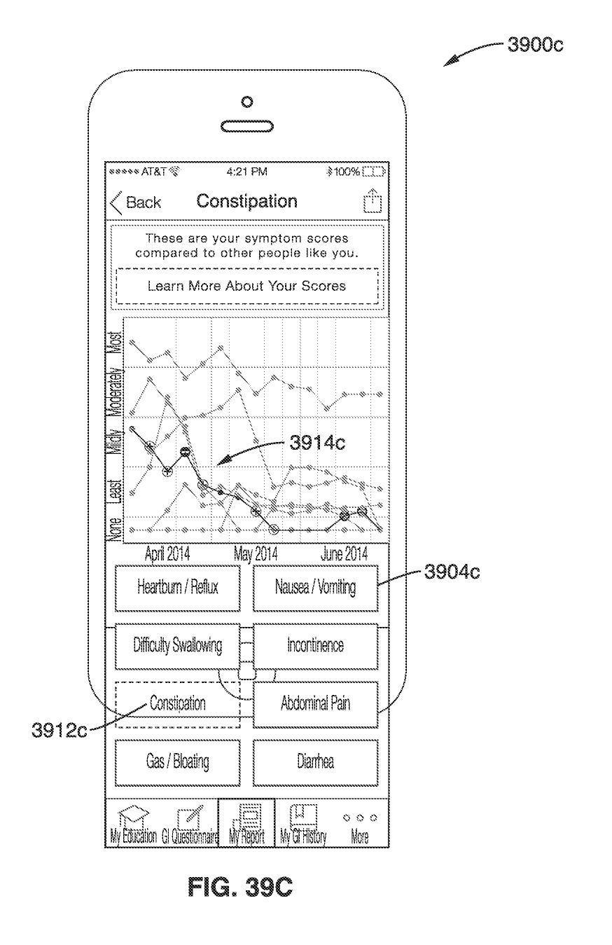

FIG. 39A through FIG. 39C show user interface screens 3900a, 3900b, 3900c that illustrate possible display changes when a user 3902 selects a different symptom tab, such as the nausea/vomiting tab 3904a shown in this example in FIG. 39A. When the user selects the nausea/vomiting tab 3904a, the heartburn/reflux tab 3906b may then be displayed in muted colors or tones (represented here as a solid box) and the nausea/vomiting tab 3904b may then be displayed in bold colors or tones (represented here as a dashed box), as shown in FIG. 39B. In addition, the corresponding symptom line graph for nausea/vomiting 3908b may also then be displayed in bold colors or tones, as shown in FIG. 39B, whereas the unselected heartburn/reflux symptom line graph 3910b may return to a muted color or tone. FIG. 39C shows how the same would happen in this example if the user 3902 selected the constipation tab 3912b (FIG. 39B). The selected constipation 3912c tab may then be displayed in bold colors or tones, along with the corresponding constipation symptom line graph 3914c. The nausea/vomiting tab 3904c may then return to a muted color or tone, like the rest of the unselected tabs and line graphs.

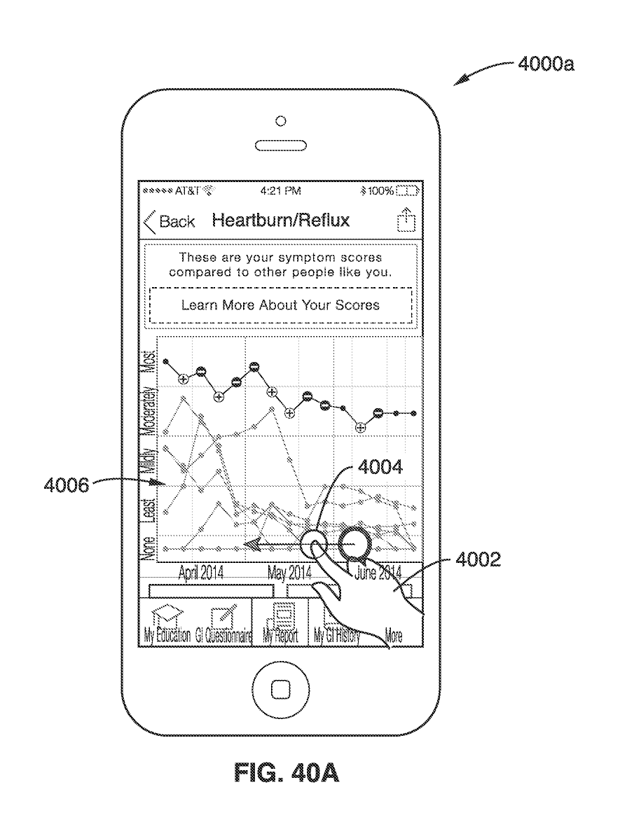

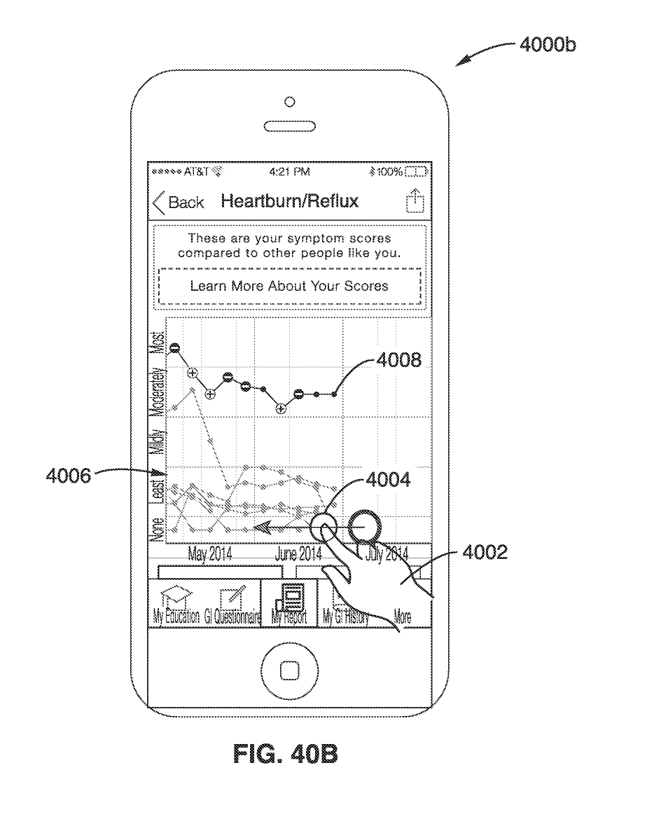

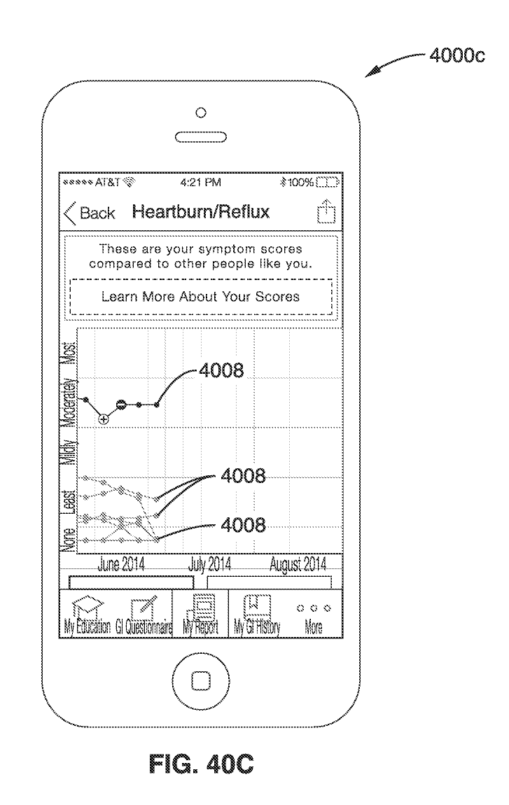

FIG. 40A through FIG. 40C show user interface screens 4000a, 4000b, 4000c which illustrate how a user 4002 can scroll 4004 through past symptom entries 4006 from the current symptom entries 4008.

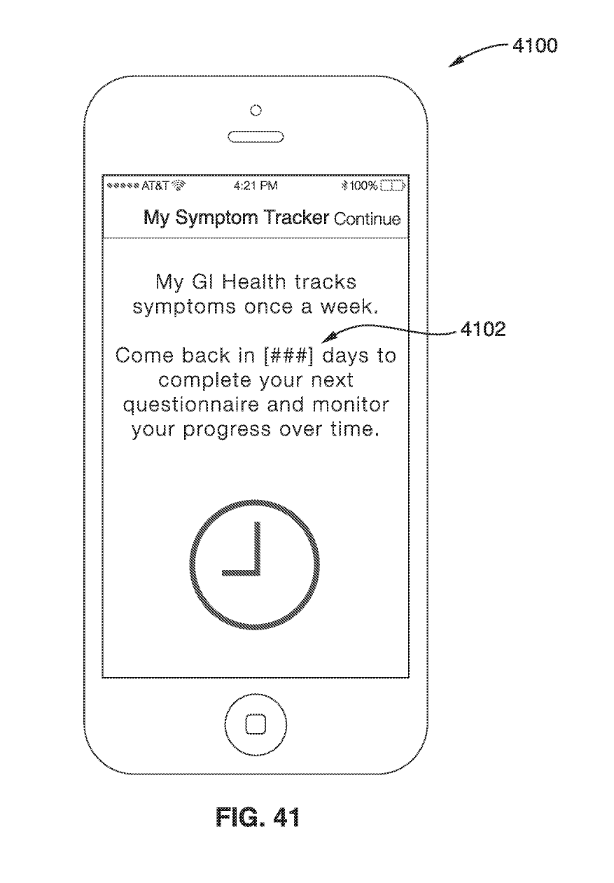

Referring to FIG. 41, one embodiment of the symptom monitoring feature may include a user interface screen 4100 that may alert a user that they have a certain number of days before they need to add another timely symptom entry. In this example, the user interface screen 4100 is displaying the number of days 4102 that are left before the user needs to add a weekly symptom entry.

The figures depict preferred embodiments of automatically evaluating medical symptoms and providing tailored prescriptions for purposes of illustration only. One skilled in the art will readily recognize from the accompanying discussion that alternative embodiments of the structures and methods illustrated herein may be employed without departing from the principles described herein.

Upon reading this disclosure, those of skill in the art will appreciate still additional alternative structural and functional designs for automatically evaluating medical symptoms and providing tailored prescriptions. Thus, while particular embodiments and applications have been illustrated and described, it is to be understood that the disclosed embodiments are not limited to the precise configurations and components disclosed herein. Various modifications, changes and variations, which will be apparent to those skilled in the art, may be made in the arrangement, operation and details of the method and apparatus disclosed herein without departing from the spirit and scope defined in the appended claims.

It will be appreciated that the disclosed embodiments may be described with reference to flowchart illustrations of methods and systems, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

It will further be appreciated that “programming” as used herein refers to one or more instructions that can be executed by a processor to perform a function as described herein. The programming can be embodied in software, in firmware, or in a combination of software and firmware. The programming can be stored local to the device in nontransitory media, or can be stored remotely such as on a server, or all or a portion of the programming can be stored locally and remotely. Programming stored remotely can be downloaded (pushed) to the device by user initiation, or automatically based on one or more factors.

It will further be appreciated that as used herein, that the terms processor, central processing unit (CPU), and computer are used synonymously to denote a device capable of executing the programming and communication with input/output interfaces and/or peripheral devices.

From the description herein, it will be appreciated that that the present disclosure encompasses multiple embodiments which include, but are not limited to, the following:

1. A computerized method for automatically evaluating medical symptoms and providing a tailored prescription, the method comprising: (a) receiving, at a processor of a computing device, data representative of a medical patient questionnaire information, wherein the medical patient questionnaire information includes information regarding symptoms related to a medical condition; (b) receiving, at the processor of the computing device, data representative of medical knowledge information based on the data representative of the medical patient questionnaire information, wherein the medical knowledge information is, at least partially, based on the medical condition; (c) causing the processor to automatically generate an integrated symptoms summary based on the data representative of the medical patient questionnaire information and the data representative of the medical knowledge information; and (d) causing the processor to automatically generate a tailored prescription based on the data representative of a medical patient questionnaire, the data representative of the medical knowledge information and the data representative of the physician consultation information.

2. The method of any preceding embodiment, further comprising: receiving, at processor of a computing device, data representative of physician consultation information, wherein the physician consultation information is, at least partially, based on the integrated symptoms summary; wherein the tailored prescription is based on the data representative of a medical patient questionnaire, the data representative of the medical knowledge information and the data representative of the physician consultation information

3. The method of any preceding embodiment, wherein at least one of: the medical patient questionnaire information, the integrated symptoms summary and the tailored prescription is customizable.

4. The method of any preceding embodiment, wherein the medical patient questionnaire information includes information related to at least one of: patient personal information; patient educational needs; abdominal or belly pain; bowel incontinence; heartburn, acid reflux, or gastroesophageal reflux; bloating or swelling in the belly; diarrhea; constipation; and nausea or vomiting.

5. The method of any preceding embodiment, further comprising causing the processor to automatically generate the integrated symptoms summary with information related to at least one of: constipation, gas/bloating, heartburn/reflux, diarrhea, dysphagia, abdominal pain, nausea/vomiting, and incontinence.

6. The method of any preceding embodiment, wherein the physician consultation information includes at least one of: patient questions, physician responses to patient questions, a physician diagnosis and a physician recommended treatment.

7. The method of any preceding embodiment, further comprising causing the processor to automatically generate the tailored prescription with at least one of: educational material related to the symptoms, educational material related to a diagnosis, educational material related to a treatment, educational material related to medication and educational material related to prevention or diagnostic testing.

8. The method of any preceding embodiment, further comprising providing at least a portion of the tailored prescription as feedback to the medical knowledge resource.

9. The method of any preceding embodiment, further comprising: comparing symptoms related to the medical condition of a first patient to a database of symptoms of a plurality of patients; and generating a group of patients having symptoms matching or resembling each other.

10. The method of any preceding embodiment, further comprising: providing an online interface allowing the first patient to identify other patients matching or resembling the first patient's symptoms.

11. The method of any preceding embodiment, wherein generating a group of patients is performed via multi-dimensional matching.

12. The method of any preceding embodiment, wherein the multi-dimensional matching is based on data in the symptoms summary.

13. The method of any preceding embodiment, wherein the symptoms are measured according to severity and scored corresponding to a ranking within a population of patients and categorized into a plurality of levels.

14. The method of any preceding embodiment, further comprising: generating a heat map to visually demonstrate the scored rankings of each patient.

15. The method of any preceding embodiment, wherein a patient is categorized across a plurality of symptoms within the symptoms summary.

16. The method of any preceding embodiment, wherein the multi-dimensional matching comprises matching one or more patients who share symptoms that fall within a band of the heat map.

17. A system for automatically evaluating medical symptoms and providing a tailored prescription, the system comprising: (a) a first computing device for presenting a medical patient user interface to a patient for entering information regarding symptoms related to a medical condition; (b) a medical knowledge resource database that includes information related to the medical condition; (c) an integrated symptoms summary generator module stored on a computer-readable medium that, when executed by a processor, receives data representative of the information regarding symptoms related to the medical condition and data representative of information related to the medical condition and generates an integrated symptoms summary based on data representative of the information regarding symptoms and the data representative of information related to the medical condition; (d) a second computing device for presenting a physician user interface for entering physician consultation information; and (e) a tailored prescription generator module stored on a computer-readable medium that, when executed by a processor, receives data representative of the symptoms, data representative of the information related to the medical condition and data representative of the physician consultation information and generates a tailored prescription based on data representative of the information regarding the symptoms, data representative of the information related to the medical condition and data representative of the physician consultation information.

18. The system of any preceding embodiment, wherein the medical patient questionnaire information includes information related to at least one of: patient personal information and information related to a medical condition.

19. The system of any preceding embodiment, wherein the integrated symptoms summary module compares data representative of the medical patient questionnaire to data in the medical knowledge database and provides information related to diagnosis and treatment of the medical condition.

20. The system of any preceding embodiment, wherein the physician consultation information includes at least one of: patient questions, physician responses to patient questions, a physician diagnosis of the medical condition and a physician recommended treatment for the medical condition.

21. The system of any preceding embodiment, wherein the tailored prescription includes at least one of: educational material related to the symptoms, educational material related to a diagnosis, educational material related to a treatment, educational material related to medication and educational material related to prevention.

22. The system of any preceding embodiment, wherein at least a portion of the tailored prescription is provided as feedback to modify the integrated symptoms summary.

23. The system of any preceding embodiment, further comprising: a symptom matching module for comparing symptoms related to the medical condition of a first patient to a database of symptoms of a plurality of patients and generating a group of patients having symptoms matching or resembling each other.

24. The system of any preceding embodiment, the matching module further configured for providing an online interface allowing the first patient to identify other patients matching or resembling the first patient's symptoms.

25. The system of any preceding embodiment, wherein generating a group of patients is performed via multi-dimensional matching.

26. The system of any preceding embodiment, wherein the multi-dimensional matching is based on data in the symptoms summary.

27. The system of any preceding embodiment, wherein the symptoms are measured according to severity and scored corresponding to a ranking within a population of patients and categorized into a plurality of levels.

28. The system of any preceding embodiment, the matching module further configured for generating a heat map to visually demonstrate the scored rankings of each patient.

29. The system of any preceding embodiment, wherein a patient is categorized across a plurality of symptoms within the symptoms summary.

30. The system of any preceding embodiment, wherein the multi-dimensional matching comprises matching one or more patients who share symptoms that fall within a band of the heat map.

31. A computer-readable storage medium comprising: nontransitory computer-readable instructions stored thereon and to be executed on a processor of a system for automatically evaluating medical symptoms and providing a tailored prescription, the stored instructions comprising: a tailored prescription generator module that, when executed by a processor, receives data representative of symptoms related to a medical condition of a patient, data representative of information related to the medical condition from a medical knowledge source and data representative of a physician consultation information and generates a tailored prescription based on data representative of the information regarding the symptoms, data representative of the information related to the medical condition and data representative of the physician consultation information, wherein the data representative of the physician consultation information is, at least partially, based on an integral symptoms summary that is generated using data representative of a symptoms of the patient and data representative of a medical knowledge source.

32. The computer-readable medium of any preceding embodiment, wherein the stored instructions further comprise: a communication module that, when executed by a processor, communicates the tailored prescription from a first computing device to a second computing device.

33. The computer-readable medium of any preceding embodiment, wherein the stored instructions further comprise: a feedback module that, when executed by a processor, transmits data representative of at least a portion of the tailored prescription to the medical knowledge source.

34. The computer-readable medium of any preceding embodiment, wherein the stored instructions further comprise: a communication module that, when executed by a processor, retrieves the data representative of the information regarding the symptoms from a first computing device.

35. The computer-readable medium of any preceding embodiment, wherein the communication module retrieves the data representative of the physician consultation information from a second computing device.

36. The computer-readable medium of any preceding embodiment, wherein the communication module retrieves the data representative of the information related to the medical condition from a third computing device.

37. The computer-readable medium of any preceding embodiment, wherein the stored instructions further comprise: a customization module that, when executed by a processor, presents a customization user interface which allows customization of at least one of: a patient questionnaire, an integrated symptoms summary, reports and a tailored prescription.

38. The computer-readable medium of any preceding embodiment, wherein the stored instructions further comprise: a symptom matching module for comparing symptoms related to the medical condition of a first patient to a database of symptoms of a plurality of patients and generating a group of patients having symptoms matching or resembling each other.

39. The computer-readable medium of any preceding embodiment, the matching module further configured for: providing an online interface allowing the first patient to identify other patients matching or resembling the first patient's symptoms.

40. The computer-readable medium of any preceding embodiment, wherein generating a group of patients is performed via multi-dimensional matching.

41. The computer-readable medium of any preceding embodiment, wherein the multi-dimensional matching is based on data in the symptoms summary.

42. The computer-readable medium of any preceding embodiment, wherein the symptoms are measured according to severity and scored corresponding to a ranking within a population of patients and categorized into a plurality of levels.

43. The computer-readable medium of any preceding embodiment, the matching module further configured for: generating a heat map to visually demonstrate the scored rankings of each patient.

44. The computer-readable medium of any preceding embodiment, wherein a patient is categorized across a plurality of symptoms within the symptoms summary.

45. The computer-readable medium of any preceding embodiment, wherein the multi-dimensional matching comprises matching one or more patients who share symptoms that fall within a band of the heat map.

46. A computerized method for automatically evaluating medical symptoms, the method comprising: (a) receiving, at a processor of a computing device, data representative of a medical patient questionnaire information, wherein the medical patient questionnaire information includes information regarding symptoms related to a medical condition; (b) receiving, at the processor of the computing device, data representative of medical knowledge information based on the data representative of the medical patient questionnaire information, wherein the medical knowledge information is, at least partially, based on the medical condition; and (c) generating an image corresponding to data relating to one or more of the medical condition symptoms, said image providing a visualization of changes with respect to the one or more of the medical condition symptoms.

47. The method of any preceding embodiment, wherein the data relating to one or more of the medical condition symptoms is a function of the data representative of the medical patient questionnaire information and the data representative of the medical knowledge information.

48. The method of any preceding embodiment, further comprising: generating one or more graphical indicators within the image; wherein the one or more graphical indicators represent that a change with respect to a symptom exceeds a predetermined minimally clinically important difference.

49. The method of any preceding embodiment, wherein the predetermined minimally clinically important difference is based on psychometric principles to distinguish between changes that are noise and changes that are clinically important.

50. The method of any preceding embodiment, wherein the image comprises a plurality of plots representing baseline symptom scores across multiple symptoms relating to a medical condition.

51. The method of any preceding embodiment, wherein one of the multiple symptoms may be selected to highlight the symptom while muting non-selected symptoms.

52. The method of any preceding embodiment, wherein the baseline symptom scores represent changes of symptom score over time.

Although the description herein contains many details, these should not be construed as limiting the scope of the technology but as merely providing illustrations of some of the presently preferred embodiments of this technology. Therefore, it will be appreciated that the scope of the present technology fully encompasses other embodiments which may become obvious to those skilled in the art, and that the scope of the present technology is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present technology, for it to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for.” No claim element herein is to be construed as a “step plus function” element unless the element is expressly recited using the phrase “step for.”

What is claimed is:

1. A computerized method for automatically evaluating medical symptoms and providing a tailored prescription, the method comprising:
(a) receiving, at a processor of a computing device, data representative of a medical patient questionnaire information, wherein the medical patient questionnaire information includes information regarding symptoms related to a medical condition;
(b) receiving, at the processor of the computing device, data representative of medical knowledge information based on the data representative of the medical patient questionnaire information, wherein the medical knowledge information is, at least partially, based on the medical condition;
(c) causing the processor to automatically generate an integrated symptoms summary based on the data representative of the medical patient questionnaire information and the data representative of the medical knowledge information; and
(d) causing the processor to automatically generate a tailored prescription based on the data representative of a medical patient questionnaire, the data representative of the medical knowledge information and the data representative of the physician consultation information.

2. The method of claim 1, further comprising:
receiving, at processor of a computing device, data representative of physician consultation information, wherein the physician consultation information is, at least partially, based on the integrated symptoms summary;
wherein the tailored prescription is based on the data representative of a medical patient questionnaire, the data representative of the medical knowledge information and the data representative of the physician consultation information

3. The method of claim 2, wherein at least one of: the medical patient questionnaire information, the integrated symptoms summary and the tailored prescription is customizable.

4. The method of claim 2, wherein the medical patient questionnaire information includes information related to at least one of: patient personal information; patient educational needs; abdominal or belly pain; bowel incontinence; heartburn, acid reflux, or gastroesophageal reflux; bloating or swelling in the belly; diarrhea; constipation; and nausea or vomiting.

5. The method of claim 2, further comprising causing the processor to automatically generate the integrated symptoms summary with information related to at least one of: constipation, gas/bloating, heartburn/reflux, diarrhea, dysphagia, abdominal pain, nausea/vomiting, and incontinence.

6. The method of claim 2, wherein the physician consultation information includes at least one of: patient questions, physician responses to patient questions, a physician diagnosis and a physician recommended treatment.

7. The method of claim 2, further comprising causing the processor to automatically generate the tailored prescription with at least one of: educational material related to the symptoms, educational material related to a diagnosis, educational material related to a treatment, educational material related to medication and educational material related to prevention or diagnostic testing.

8. The method of claim 2, further comprising providing at least a portion of the tailored prescription as feedback to the medical knowledge resource.

9. The method of claim 2, further comprising:
comparing symptoms related to the medical condition of a first patient to a database of symptoms of a plurality of patients; and
generating a group of patients having symptoms matching or resembling each other.

10. The method of claim 9, further comprising:
providing an online interface allowing the first patient to identify other patients matching or resembling the first patient's symptoms.

11. The method of claim 9, wherein generating a group of patients is performed via multi-dimensional matching.

12. The method of claim 11, wherein the multi-dimensional matching is based on data in the symptoms summary.

13. The method of claim 12, wherein the symptoms are measured according to severity and scored corresponding to a ranking within a population of patients and categorized into a plurality of levels.

14. The method of claim 13, further comprising:
generating a heat map to visually demonstrate the scored rankings of each patient.

15. The method of claim 14, wherein a patient is categorized across a plurality of symptoms within the symptoms summary.

16. The method of claim 14, wherein the multi-dimensional matching comprises matching one or more patients who share symptoms that fall within a band of the heat map.

17. A system for automatically evaluating medical symptoms and providing a tailored prescription, the system comprising:
(a) a first computing device for presenting a medical patient user interface to a patient for entering information regarding symptoms related to a medical condition;
(b) a medical knowledge resource database that includes information related to the medical condition;
(c) an integrated symptoms summary generator module stored on a computer-readable medium that, when executed by a processor, receives data representative of the information regarding symptoms related to the medical condition and data representative of information related to the medical condition and generates an integrated symptoms summary based on data representative of the information regarding symptoms and the data representative of information related to the medical condition;
(d) a second computing device for presenting a physician user interface for entering physician consultation information; and
(e) a tailored prescription generator module stored on a computer-readable medium that, when executed by a processor, receives data representative of the symptoms, data representative of the information related to the medical condition and data representative of the physician consultation information and generates a tailored prescription based on data representative of the information regarding the symptoms, data representative of the information related to the medical condition and data representative of the physician consultation information.

18. The system of claim 17, wherein the medical patient questionnaire information includes information related to at least one of: patient personal information and information related to a medical condition.

19. The system of claim 17, wherein the integrated symptoms summary module compares data representative of the medical patient questionnaire to data in the medical knowledge database and provides information related to diagnosis and treatment of the medical condition.

20. The system of claim 17, wherein the physician consultation information includes at least one of: patient questions, physician responses to patient questions, a physician diagnosis of the medical condition and a physician recommended treatment for the medical condition.

21. The system of claim 20, wherein the tailored prescription includes at least one of: educational material related to the symptoms, educational material related to a diagnosis, educational material related to a treatment, educational material related to medication and educational material related to prevention.

22. The system of claim 21, wherein at least a portion of the tailored prescription is provided as feedback to modify the integrated symptoms summary.

23. The system of claim 17, further comprising:
a symptom matching module for comparing symptoms related to the medical condition of a first patient to a database of symptoms of a plurality of patients and generating a group of patients having symptoms matching or resembling each other.

24. The system of claim 23, the matching module further configured for providing an online interface allowing the first patient to identify other patients matching or resembling the first patient's symptoms.

25. The system of claim 23, wherein generating a group of patients is performed via multi-dimensional matching.

26. The system of claim 25, wherein the multi-dimensional matching is based on data in the symptoms summary.

27. The system of claim 26, wherein the symptoms are measured according to severity and scored corresponding to a ranking within a population of patients and categorized into a plurality of levels.

28. The system of claim 27, the matching module further configured for generating a heat map to visually demonstrate the scored rankings of each patient.

29. The system of claim 28, wherein a patient is categorized across a plurality of symptoms within the symptoms summary.

30. The system of claim 28, wherein the multi-dimensional matching comprises matching one or more patients who share symptoms that fall within a band of the heat map.

31. A computer-readable storage medium comprising nontransitory computer-readable instructions stored thereon and to be executed on a processor of a system for automatically evaluating medical symptoms and providing a tailored prescription, the stored instructions comprising:
a tailored prescription generator module that, when executed by a processor, receives data representative of symptoms related to a medical condition of a patient, data representative of information related to the medical condition from a medical knowledge source and data representative of a physician consultation information and generates a tailored prescription based on data representative of the information regarding the symptoms, data representative of the information related to the medical condition and data representative of the physician consultation information, wherein the data representative of the physician consultation information is, at least partially, based on an integral symptoms summary that is generated using data representative of a symptoms of the patient and data representative of a medical knowledge source.

32. The computer-readable medium of claim 31, wherein the stored instructions further comprise:
a communication module that, when executed by a processor, communicates the tailored prescription from a first computing device to a second computing device.

33. The computer-readable medium of claim 31, wherein the stored instructions further comprise:
a feedback module that, when executed by a processor, transmits data representative of at least a portion of the tailored prescription to the medical knowledge source.

34. The computer-readable medium of claim 31, wherein the stored instructions further comprise:
a communication module that, when executed by a processor, retrieves the data representative of the information regarding the symptoms from a first computing device.

35. The computer-readable medium of claim 34, wherein the communication module retrieves the data representative of the physician consultation information from a second computing device.

36. The computer-readable medium of claim 35, wherein the communication module retrieves the data representative of the information related to the medical condition from a third computing device.

37. The computer-readable medium of claim 31, wherein the stored instructions further comprise:
a customization module that, when executed by a processor, presents a customization user interface which allows customization of at least one of: a patient questionnaire, an integrated symptoms summary, reports and a tailored prescription.

38. The computer-readable medium of claim 31, wherein the stored instructions further comprise:
a symptom matching module for comparing symptoms related to the medical condition of a first patient to a database of symptoms of a plurality of patients and generating a group of patients having symptoms matching or resembling each other.

39. The computer-readable medium of claim 37, the matching module further configured for:
providing an online interface allowing the first patient to identify other patients matching or resembling the first patient's symptoms.

40. The computer-readable medium of claim 37, wherein generating a group of patients is performed via multi-dimensional matching.

41. The computer-readable medium of claim 40, wherein the multi-dimensional matching is based on data in the symptoms summary.

42. The computer-readable medium of claim 41, wherein the symptoms are measured according to severity and scored corresponding to a ranking within a population of patients and categorized into a plurality of levels.

43. The computer-readable medium of claim 42, the matching module further configured for:
generating a heat map to visually demonstrate the scored rankings of each patient.

44. The computer-readable medium of claim 43, wherein a patient is categorized across a plurality of symptoms within the symptoms summary.

45. The computer-readable medium of claim 43, wherein the multi-dimensional matching comprises matching one or more patients who share symptoms that fall within a band of the heat map.

46. A computerized method for automatically evaluating medical symptoms, the method comprising:
(a) receiving, at a processor of a computing device, data representative of a medical patient questionnaire information, wherein the medical patient questionnaire information includes information regarding symptoms related to a medical condition;
(b) receiving, at the processor of the computing device, data representative of medical knowledge information based on the data representative of the medical patient questionnaire information, wherein the medical knowledge information is, at least partially, based on the medical condition; and
(c) generating an image corresponding to data relating to one or more of the medical condition symptoms, said image providing a visualization of changes with respect to the one or more of the medical condition symptoms.

47. The method of claim 46, wherein the data relating to one or more of the medical condition symptoms is a function of the data representative of the medical patient questionnaire information and the data representative of the medical knowledge information.

48. The method of claim 47, further comprising:
generating one or more graphical indicators within the image;
wherein the one or more graphical indicators represent that a change with respect to a symptom exceeds a predetermined minimally clinically important difference.

49. The method of claim 48, wherein the predetermined minimally clinically important difference is based on psychometric principles to distinguish between changes that are noise and changes that are clinically important.

50. The method of claim 47, wherein the image comprises a plurality of plots representing baseline symptom scores across multiple symptoms relating to a medical condition.

51. The method of claim 50, wherein one of the multiple symptoms may be selected to highlight the symptom while muting non-selected symptoms.

52. The method of claim 50, wherein the baseline symptom scores represent changes of symptom score over time.
